(19) United States
(12) Patent Application Publication
(10) Pub. No.: US 2006/0247967 A1
(43) Pub. Date: Nov. 2, 2006

(54) Method of marketing maturing consumable products and products useful therein

(76) Inventors: Thaddeus Prusik, Stroudsburg, PA (US); Jean-Paul Martin, London (GB); Serge P. Gozlan, Paris (FR)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/119,650

(22) Filed: May 2, 2005

(51) Int. Cl. G06Q 99/00; G07G 1/14; G06Q 30/00

(52) U.S. Cl. 705/14; 705/1

(57) ABSTRACT

A marketing process for a maturing consumable product, especially one lacking a clear visual indication of maturity or ripeness, e.g. certain pears, other fruit, some cheeses, aged beef, sausages and wine, employs a visual indicator responsive to cumulative exposure to temperature, humidity, atmospheric conditions and/or other environmental conditions. The maturity indicator responds by changing its visual appearance, or providing another signal, after elapse of a condition exposure correlated with the conditions anticipated to be required for a desired maturity stage of the maturing product. Optionally the indicator can be incorporated in a label adhered to the maturing product. The indicator can employ various indicator technologies including an active chemical agent, e.g. a polyacetylenic agent, adhesive diffusion technology, an oxidative reaction, a silver salt redox reaction, an enzyme based reaction or an electronic condition exposure indicator. The visual indicator can enable a customer readily to determine the ripeness or maturity of a product without having to handle it or otherwise physically inspect it.

### STATEMENT REGARDING FEDERALLY SPONSORED RESEARCH OR DEVELOPMENT

(Not applicable.)

### BACKGROUND OF THE INVENTION

The present invention relates to a method of marketing products for human or animal consumption, “consumable products” hereinafter, that require maturation or ripening to attain desirable or peak qualities that will provide good customer or consumer acceptance, at a point of customer or consumer inspection. The point of customer inspection may be a point of sale, e.g. in a store, or a point of delivery, e.g. to the customer's home or business, or in the customer's home or business, or another suitable point in the distribution chain.

The invention also relates to novel consumable products and maturity or ripeness indicators useful in practicing the method of the invention. While many consumable products, for example most, but not all meats, most fish, orange juice, milk, breads and pastries and the like, deteriorate as they pass through the distribution chain from producer to consumer, some products actually may improve.

Certain consumable products including, for example, but without limitation, cheese, beef, wine, fresh fruit and vegetable or fruit products, e.g. pears, are initially packaged, bottled, or harvested before they attain peak quality characteristics that will provide good or optimal consumer satisfaction. Such immature shipment from the grower or packer is employed to allow natural biochemical processes to take place in the product during storage and distribution to provide desirable final qualities at a point-of-sale, -use or -delivery. The various biochemical maturation, or ripening, processes require particular time and temperature exposure to yield a marketable product or optimum results. Appropriate temperature exposure for adequate time, within the package if the product is packaged, is often of paramount concern in order to deliver the desired consumer acceptance of the end product.

In contrast to most perishable consumable products which deteriorate with the passage of time, the present invention relates to consumable products which ultimately are perishable, but which can actually improve in quality, or desirability to some consumers, with the passage of time after production, harvesting, storage, or packaging. Pursuant to the invention, it would be desirable to provide a means whereby a consumer or other customer or interested party can easily make a judgment as to whether the product has a maturity suiting their preference. The degree of maturity can be selected by the product supplier and may, for example, be an optimal or mean value corresponding with a product quality that will appeal to a large proportion of prospective customers.

Some products have a built-in visual indicator of the extent of ripening, for example the skin of some fruits e.g. bananas, changes color as the fruit ripens. Bananas are harvested when green in color, ripen to yellow and turn brown, when they have passed their normal prime condition. Furthermore, bananas, and other fruits, are often shipped in opaque boxes or other containers that make it difficult or impossible to judge the ripeness of the fruit within by its visual appearance, without opening the box.

Other maturing consumable products, e.g. wine, cheese, and fruits such as Anjou pears, do not show visual changes that can be easily interpreted by interested parties to assess the extent of ripening. Moreover, pears must usually be harvested before they are tree ripe. Pears that completely ripen prior to harvest are “mushy” and may be gritty and are not desired by consumers. Accordingly, it is important to harvest the pear prior to complete ripening and to allow the pears to achieve a desired state of maturity after transport and storage. This post-harvest ripening is a time and temperature driven process. Because they may exhibit little color change during ripening, determining maturity can be difficult and consumers often take home pears that are surprisingly hard and unripe.

One test of ripeness of pears is to press on the fruit, desirably near the stem end, to feel some “give”. This is not desired in a retail outlet as various products will be damaged by this probing and not be saleable resulting in monetary loss.

To help meet the goal of providing pears to consumers in a desirable condition, it has been proposed to monitor the maturity of the ripening pear by employing a chemically sensitive color changing indicator to detect one or more chemical compounds emitted by the fruit during ripening. The pears and the indicator are enclosed together in a container which is provided with limited airflow. The indicator changes color to signal the degree of ripeness and a reference guide is provided in the package, to relate the indicator colors to the degree of ripeness.

Such a product has reportedly been marketed by The Pear Bureau Northwest, Milwaukee, Oreg., at supermarkets employing a clear polyester clamshell four-packs of green Anjou pears, which do not change color as they ripen (“the Pear Bureau product” hereinafter). A RIPESENSE™ sensor from the Jenkins Group (“the Jenkins sensor” hereinafter) is affixed inside the lid of the clamshell. The clamshells are thermoformed with feet to permit stacking and have a 6 mm diameter hole in the bottom of each of the pack's four compartments to provide air flow. The clamshell lid friction-fits into the base and is secured with a pressure-sensitive label that provides evidence of tampering. The label is printed with a ripening indicator scale ranging from crisp (orange) to juicy (yellow) is prominently affixed to the clamshell package. The sensor has a color changing chemistry that responds to the ripening aromas of the fruit. Before packing by the grower, the fruit is ethylene conditioned to hasten and equalize the pears' ripening. The indicator color visually indicates the pears' ripeness in a manner which a customer can understand by referencing a ripeness scale on an accompanying label. The packs carry no use-by or fresh-by date. The pears' typical shelf life is three to five days, although refrigeration, if employed, will slow ripening. It is not clear to what extent variations in convection through the packages may affect the ripeness indicator.

Pursuant to the present invention, it may be understood that undue convection caused by local drafts or wind conditions might reduce the concentration of volatile agent in the package of the Pear Bureau product. Alternatively, blockage of the ventilation holes by another package, or other object, could cause an increased concentration of volatile within the package. Either eventuality could lead to inaccurate ripeness indications. Furthermore, the Pear Bureau product requires a containing package for the fruit to trap the chemical agents in the ripening aromas and is clearly unsuitable for use with fruit which is marketed as loose unpackaged pieces, as is the case for most supermarket supplied fruit in 2005. In addition, there exist a number of maturing consumable products whose ripeness or maturity it would be desirable to monitor which do not release suitable volatiles for detection by a monitor.

Hong et al. in an academic paper “Application of Time-temperature Indicators for Monitoring Kimchi Fermentation” Food Sci. Biotechnol. Vol. 9, No. 4, pp. 258-262 (2000) disclose studies to examine the application of commercially available time-temperature indicators (“TTIs”) as nondestructive fermentation monitors for kimchi products. Two different time-temperature indicators were studied: a polymeric-based time temperature indicator (TTI₁) Lot G267 obtained from LifeLines Technology, Morris Plains, N.J., (the former name of TEMPTIME Corporation, the current owner of this patent application); and an enzyme-based indicator (TTI₂), VITSAB® TTI tag, standard type M10-0010, Malmö, Sweden. Hong et al. note that the response times of the TTIs “are reported to be” 8 and 10 days respectively at 10° C. and therefore are “in accordance with the optimum fermentation period of baechu kimchi” (page 260, top of the righthand column), suggesting to the reader an element of chance in the apparent correlation between the response times and the optimum fermentation period. Furthermore, the response times of 8 and 10 days are not suitable for many consumable products such as cheeses and wines which may have much longer maturation periods.

Kimchi is an exotic Asian food product, with its own technology, which is quite unlike everyday food items such as cheeses, meats, wines and fruits, specifically, kimchi is a Korean gourmet product, comprising fermented Chinese cabbage (baechu kimchi).

Hong et al. note the problem that, after optimum fermentation, the quality of kimchi deteriorates rapidly (page 258, 5 lines up from the bottom of the lefthand column). Hong et al. describe, a main purpose of the application of TTIs to kimchi packaging as being to easily and reliably monitor the ripeness of the product (page 261, 6 lines up from the bottom of the lefthand column), presumably to avoid deteriorated product. Hong et al. appear to be speculating as to the usefulness of their findings and do not describe a commercial product. They merely suggest that TTIs could be applied to kimchi for monitoring the fermentation. Cryptically, they conclude that proper use of TTIs would enable consumers to test ripeness, leaving uncertainties as to what would constitute proper use and what sort of test the consumer should make to determine ripeness. Furthermore, Hong et al. employ a sophisticated light meter to measure color changes of the TTI (page 259, top of the righthand column) that it would be impractical for consumers to use in a store or other location.

Notwithstanding the foregoing proposals, there is a need in the art for a widely applicable marketing method that will enable customers to easily know that a maturing consumable product has attained a desirable or peak quality condition.

The foregoing description of background art may include insights, discoveries, understandings or disclosures, or associations together of disclosures, that were not known to the relevant art prior to the present invention but which were provided by the invention. Some such contributions of the invention may have been specifically pointed out herein, whereas other such contributions of the invention will be apparent from their context. Merely because a document may have been cited here, no admission is made that the field of the document, which may be quite different from that of thesinvention, is analogous to the field or fields of the present invention.

### SUMMARY OF THE INVENTION

It is an object of the present invention to provide a method of marketing a maturing consumable product, which employs a visual indicator of the maturity or maturity of the maturing product, and which can be employed with a wide variety of maturing consumable products including loose unpackaged items. It is another object of the invention to provide such a method of marketing which employs a visual indicator suitable for attachment to individual product items or to boxes, cartons, or other packages containing the product items.

Other objects will be apparent from the disclosure herein and include the provision of a maturing consumable product provided with a visible ripeness or maturity indicator responsive to environmental ripening conditions and which is not dependent upon detection of volatiles released by the host product.

Accordingly, in one aspect, the invention provides a process for marketing a maturing consumable product, the process comprising providing a visual environmental condition indicator with the maturing consumable product and selecting the visual environmental condition indicator to have a response providing a visual indication correlated with a desired maturity of the consumable product.

The environmental condition indicator can indicate cumulative temperature or humidity exposure, exposure to an externally applied gas such as carbon dioxide or ethylene which can affect the maturation or ripening of some consumable products, or other useful environmental parameter.

In one embodiment of the invention the marketing process comprises:
a) determining the degree of maturity of the maturing consumable product prior to application of the environmental condition indicator;
b) selecting a degree of maturity of the consumable product to provide the desired maturity at a point of customer inspection;
c) determining a cumulative temperature exposure over time to provide the desired maturity of the consumable product;
d) selecting as the environmental condition-sensitive visual indicator a temperature-sensitive visual indicator having response characteristics corresponding with the determined cumulative temperature exposure to indicate when the desired degree of maturity of the consumable product has been reached; and
e) associating one of said time-temperature indicators with each consumable product unit to indicate product maturity at the point of customer inspection;
   wherein the visual indicator has a distinctive appearance different from an initial appearance when the cumulative temperature exposure has occurred.

In another aspect, the invention provides a maturing consumable product having a predictable temperature-related maturity profile and a maturity indicator visually associated with the consumable product the maturity indicator being temperature responsive to provide a visual indication predicted to correspond with a desired maturity of the consumable product.

Usefully, the maturity indicator can be cumulatively responsive to temperature exposure over time, provides a visual indication of a predetermined cumulative temperature exposure and is correlated with the temperature-related maturity profile of the consumable product to provide a visual indication of a desired maturity at the expiry of the predetermined cumulative temperature exposure.

The maturity indicator can be initiated in any desired manner, for example, in the case of a polymerization reaction indicator by removal of the indicator or an active element thereof from cold storage and promptly associating it with a desired host product, e.g. a cheese or cheese piece, whose maturation is to be monitored, for example by being affixed thereto. Other types of indicator can be employed and initiated in any suitable manner, e.g. by removal of a release sheet and engagement of the resultant exposed surface with a cooperative component of the indicator.

In one useful embodiment of the invention, the response parameters of the maturity indicator's active component are selected according to the particular point in the host product maturation or production process where the respective maturation indicator is to be initiated or affixed. Desirably, the selection is made so as to provide a visual indication of probable maturity after the aged meat, fruit, cheese, wine or other host product has experienced a desired time-temperature exposure expected to provide a desired maturity.

Alternatively, a range of choices of maturity may be provided, for example by providing different colored signals at different maturities, to enable a customer to select from a degree of maturity according to the customer's preference. As the product matures, changes may occur in the product's organoleptic properties such as the taste and aroma of a pear or the physical properties such as the color of an apple or the hardness of a sausage. These characteristics may change as the product matures and desirable characteristics corresponding to a particular customer's preferences may develop before or after the supplier-determined peak maturity. Employment of the maturity indicator of the invention, as described herein, can enable a customer to recognize when a product has their preferred characteristics, and to readily select that product or product item from an available choice of products or product items. The product unit may be an individual consumable item, for example, a fruit, bottle of wine, cheese piece or steak, or a package or container containing multiple items, for example a tray, box or crate, or other suitable SKU. The time-temperature responsive visual indicator can be associated with the product unit in any convenient manner such that the indicator's environmental exposure is comparable with that of the consumable product, for example the indicator may be affixed to the product unit, e.g. by adhesive.

By employing a temperature-responsive ripeness or maturity indicator the invention provides a maturity indication which can be used with a variety of maturing consumable products regardless of whether they release monitorable volatiles as they mature and which does not require the product to be contained within a package with the indicator, although such package may be used, if desired. Customers or others can quickly and easily determine ripeness or maturity simply by reading the visual indicator, without physically handling the product; which may be more convenient for the customer and may reduce spoilage of delicate items such as pears.

In either, or both, the marketing process or the maturing consumable product of the invention the indicator can comprise a label attachable, optionally by means of adhesive, to a unit of the consumable product. In one embodiment of the invention, the label comprises a reference area facilitating visual determination of the appearance of the indicator. In another embodiment of the invention, the visual indicator provides multiple appearances in response to different cumulative temperature exposures and the indicator label is a multi-stage label having multiple reference areas useful for determining the visual appearance of the indicator at multiple stages of cumulative temperature exposure over time.

The invention can be beneficially employed with a variety of maturing consumable products, for example a product selected from the group consisting of: fruits; apples; pears; kiwis; melons; grapes; grapefruit; bananas; stone fruits; peaches; nectarines; plums; pineapples; mangoes; papayas; dates; guavas; peppers; avocadoes; tomatoes; cheeses; soft cheese; brie cheese; camembert cheese; hard cheese; cheddar cheese; aging beef; aging steak; other aging meats and meat products; aging gourmet meats; gourmet hams; pheasant; gourmet game products; aging sausages; wines; Bordeaux wine, burgundy wine; claret; champagne; port; whisky; cognac; beverages that can benefit from maturation; and maturing consumable products lacking an inherent visual indication of maturity.

Various conditions, such as time-temperature exposure conditions may be employed to obtain a desired maturity of the host product, as will be known to those skilled in the art or arts. For example, a suitable cumulative time-temperature exposure to maturation for fruit may be provided by a temperature in the range of from about 5° C. to about 35° C. and a time of from about 1 day to about 30 days. Alternatively, a suitable cumulative time-temperature exposure to maturation for a cheese may be provided by a temperature in the range of from about 5° C. to about 20° C. and a time of from about 1 month to about 30 months.

The invention also provides maturity indicators and marketing methods for products that can benefit from a two-stage maturation process. For example, where the host product comprises certain fruit, a first stage cooler temperature can be in the range of from about −2° C. to about 10° C. for a first period of from about 2 days to about 1 year and a second stage, warmer temperature can be from about 10° C. to about 25° C. for a period of from about 1 day to about one month.

The indicator can comprise a chemically active agent, for example at least one polyacetylenic active substance, responsive to cumulative temperature exposure to provide a distinct change in visual appearance at the expiry of a predetermined cumulative temperature exposure. Affixing time-temperature indicators to ripening products that give little clear indication of maturity, can be beneficial to signal the product's condition during storage, transport and display until final consumption of the product.

By employing a chemical agent providing a color change or other change in appearance in response to an appropriate cumulative temperature exposure, the ripeness or maturity indicator can be provided economically and may for example be embodied in a small printed label. Such a ripeness or maturity indicator label may be adhered to the product, e.g. to the skin of a fruit, assuring that the indicator experiences similar temperature exposure to that experienced by the host product and avoiding possible adverse effects from local convection currents which a volatiles monitor might experience.

The invention also includes a marketing process and maturing consumable product helpful to people with green-red impaired color vision in determining the ripeness of maturing consumable products that display a green-to-red color change upon ripening, for example tomatoes or red apples, by providing visibly associated with the product a maturity indicator which provides a ripeness-related indication visible to people with green-red impaired color vision, for example a pronounced grayscale change in the appearance of an indicator area.

### BRIEF DESCRIPTION OF THE SEVERAL VIEWS OF THE DRAWING

Some embodiments of the invention, and of making and using the invention, as well as the best mode contemplated of carrying out the invention, are described in detail below with reference to the accompanying drawings. This description is to be read in conjunction with the preceding description and is provided by way of example. In the description below, like reference characters designate like elements throughout the several views and:

FIG. 1 is a plan view of one embodiment of a ripeness- or maturity-indicating label according to the invention;

FIG. 2 is a section on the line 2-2 of FIG. 1;

FIG. 3 is a plan view of another embodiment of ripeness-indicating label according to the invention;

FIG. 4 is a front view of a pear bearing a ripeness-indicating label according to the invention;

FIG. 5 is a plan view of a clamshell tray of pears, each being similar to the pear shown in FIG. 4; and

FIG. 6 is a schematic block flow diagram of one embodiment of marketing process according to the invention wherein the probable maturity of a maturing host product is clearly signaled by a maturity indicator which may be similar to that shown in FIG. 1.

### DETAILED DESCRIPTION OF THE INVENTION

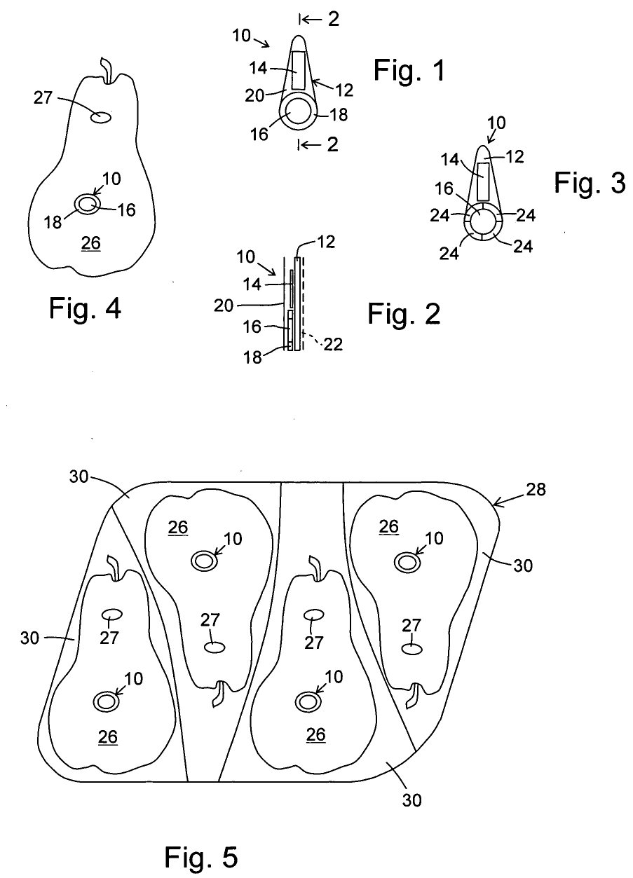

Referring to FIGS. 1-2, the ripeness- or maturity-indicating label 10 there shown comprises a printable laminar substrate 12 formed e.g. of paper, polymer film or the like. Substrate 12 bears on its front surface descriptive printed indicia 14, an active ripeness indicator 16 and a visual reference ring 18.

It will be understood that the “ripeness” of fruits, cheeses and other products, generally refers to their maturity and fitness for consumption. For other products, for example wine, the term “mature” may be more commonly or more aptly used to denote a desirable condition after keeping or aging. For the broad purposes of this invention, the terms may be used largely interchangeably, with one or the other term generally being more apt for a particular product as will be known in the respective art.

Maturity indicator 16 and reference ring 18 can also be printed, e.g. employing a silk screen, if desired. An optional transparent overlay 20 can also be employed and usefully, but not essentially, may incorporate one or more ultraviolet blockers to attenuate ultraviolet light and protect maturity indicator 16 from giving false or misleading indications in ambient sunlight or under strong fluorescent light. A foodstuffs-quality pressure-sensitive adhesive 22 covers the rear surface of substrate 12 to secure ripeness-indicating label 10 to a host product being a maturing consumable product, as described herein.

In one embodiment of the invention, the host product of the invention is marketed as a unit and a label 10 is affixed to or visually associated with the unit the unit in such a way as to clearly relate to the particular unit, for example by being physically attached thereto or contained therewith. The host product unit can comprise an individual host product item, for example a pear or a cheese, or the unit may comprise a group of multiple host product items, for example, a bunch of grapes or a package or crate of pears.

Substrate 12 may be any suitable printable paper or film material which can serve the purposes of the invention and desirably has good flexibility. For example, in one useful embodiment of the invention substrate 12 is fabricated of a synthetic polymeric material that can be precision cut to a desired size and shape, for example polyester or polypropylene, and is dyed or pigmented to be opaque white. It will be understood that substrate 12 may be another color or may be transparent. Printed material 14 may describe the host consumable product, or a source for the product, or both and can include any other desired information. Printed material 14 may of course have any desired graphical disposition on substrate 12 and need not be confined to the rectangle shown by way of example. One example of useful content for printed material 14 comprises the wording “Anjou Pear, Andy Grower & Sons, Tacoma Wash.”.

Printed material 14 may also have functional content, for example a direction to a customer or other product user, to utilize the host product item when or within a specified period after, indicator 16 attains a specified appearance, for example, the appearance of reference ring 18.

Active maturity indicator 16 desirably comprises a visual zone, e.g. the dot shown, incorporating a chemically active agent which responds cumulatively to exposure to an environmental condition such as temperature and/or humidity, which correlates with the ripening of the host product. The chemically active agent may respond, preferably irreversibly, to provide a clearly perceptible change in the appearance of maturity indicator 16. In one useful embodiment, the chemically active agent responds cumulatively, and preferably irreversibly, to environmental temperature excursions that are such as to promote ripening. Certain polyacetylenic agents are useful in this respect and suitable such materials will be further described hereinbelow. By virtue of the indicator 16 being incorporated in ripeness-indicating label 10 affixed to the ripening product itself, where the indicator will experience essentially the same environmental conditions as the host product, accurate monitoring of the particular conditions experienced by a specific product item may be obtained. The conditions experienced by one host product item may differ somewhat from those encountered by an adjacent item.

Desirably, the temperature-sensitive chemical agent is selected to have temperature response characteristics that correspond effectively with a known or predetermined ripening curve for the host consumable product so as to provide a distinct appearance change, for example a color change, in indicator 16 when the host product has attained a desired degree of ripeness. Thus, the temperature-responsive chemical agent may be selected to have a time-temperature ripeness integral running from an initiation point in time to a point in time of distinct color change, which integral corresponds with conditions effective to ripen the host product from a predetermined, or detected, point of immaturity to a desired degree of ripeness or maturity. The initiation point for time temperature indicator 16 may be a time when time-temperature indicator 16 is removed from low-temperature storage and is exposed to the same environmental conditions as the host product, for example by being affixed to the host product. Desirably, the maturity or ripeness of the host product is known, determined or estimated, at this time and a determination or estimate is also made or available of cumulative time-temperature conditions which will be appropriate for ripening of the host product to the desired degree.

Desirably also, the ripeness integral is such as to be satisfied by a variety of common environmental circumstances, such as randomly occurring days and hours of higher and lower temperature. A certain number of degree-days or degree-hours within a ripening temperature range above a base temperature determined according to the product being monitored will often be appropriate. The term a “degree-day” or “degree-hour” is used to connote the multiple of the temperature elevation and the duration of exposure at that elevated temperature. For example, one degree day may be one day at a one degree elevation or 6 hours at a 4-degree elevation and so on.

Thus, in one embodiment, in the case of many fruits, the ripening temperature may be above about 5 or 10° C. (about 40 or 50° F.), but below temperatures which rapidly deteriorate the product, for example below about 30 or 35° C. (about 86 or 95° F.). To take a particular hypothetical example, the ripeness integral for the active element of maturity indicator 16 may be selected to be say 50 Celsius degree days above 10° C. In this example, maturity indicator 16 may exhibit a visual change after 10 days exposure to temperatures of 15° C., or after 5 days exposure at 20° C., or an equivalent exposure, at the expiry of which the indicator changes appearance. In this way, the ripeness integral of the indicator can be approximately matched to the ripening needs of the particular fruit.

Reference ring 18 is an optional feature which can facilitate reading of indicator 16. For example reference ring 18 may have an appearance, e.g. a color, corresponding to a desired ripeness indication of indicator 16. A consumer or other viewer of the product may then readily determine whether contiguous indicator 16 has an appearance matching reference ring 18, indicating ripeness of the host product.

In addition to item specificity, when used in the manner described with reference to FIGS. 1-2, use of a time-temperature-sensitive chemical agent avoids difficulties that may arise with the Jenkins Group product which is intended to detect aromatic volatiles released from a host product during ripening. Such volatile detection may be affected by factors such as ventilation, e.g. windy weather carrying away the volatiles, or proximity to similar products, volatiles from one package being drawn into another package by convection when the packages are stacked or crated on top of one another. Also, few volatiles may be released during the early stages of ripening of some products, making it difficult to detect and predict a desired maturity.

If desired, when employed with ultraviolet attenuation properties, transparent overlay 20 may comprise may be dyed to filter out shorter wavelengths, being colored orange, red or another suitable color or may be transparent and incorporate an organic or inorganic antiactinic agent, for example micronized zinc oxide. Alternatively, overlay 20 may comprise an ultraviolet protective zone overlying indicator 16 which is comparably constituted. One useful embodiment of a UV-protective overlay is described and claimed in Prusik et al. U.S. patent application Ser. No. 10/457,664 filed Jun. 10, 2003, attorney docket number LL 00301.

Desirably, adhesive 22 is selected to be effective to attach label 10 securely to a host product, while permitting the label to be removed by a consumer without undue difficulty. Adhesive 22 should be of a type approved for use with foods and which is free of toxic materials, being for example a starch- or gum-based adhesive.

Label 10 can be of a size convenient for attachment to an individual host product item, for example a fruit such as a pear, melon or kiwi or other suitable maturing product. To this end label 10 may have a maximum dimension of from about 0.5 cm to about 5 cm, usefully in many embodiments of from about 1 to about 2 cm. Label 10 can have any suitable shape including rectangular, circular, oval or elliptical or can, if desired, be shaped like the host product, for example being pear-shaped for pears, melon-shaped for melons and so on.

Labels 10 such as are described hereinabove are suitable for individual application to single host product items, for example, to an individual pear, cheese, steak or bottle of wine. With appropriate matching of the chemical time-temperature sensor agent properties to the maturity and ripening cycle of the host product, indicator 16 can provide a clear visible signal of a desired degree of ripeness of the host product. Employing reference ring 18, visual determination of the end point is enhanced: it is easy for a human customer, or other person, to determine whether indicator 16 matches reference ring 18.

In the embodiment of the invention shown in FIG. 3, by way of example, reference ring 18 is divided into multiple reference areas 24, each one contiguous with indicator 16, which areas 24 can have different appearances intended to correlate with different ripeness stages of the host product. Four reference areas 24 are shown by way of example in FIG. 3. More or fewer reference areas 24 can be employed, as desired, for example from 2 to 6 areas. Reference areas 24 may have different color intensities, or other visual characteristics similar to the characteristics displayed by chemically active indicator 16 in response to different cumulative temperature exposure conditions corresponding with different stages of ripeness of the host product. For example, four reference areas 24 may indicate “Still Ripening”, “Quite Ripe”, “Fully Ripe” and “Eat Now”, or other suitable ripeness stages as may be understood by those skilled in the art.

Useful choices of ripeness conditions that may be represented by reference areas 24, according to a particular host product or particular marketing considerations, or other factors, will be apparent to those skilled in the art. For example, the phrases “still ripening”, “nearly ripe”, “ripe” and “eat now” might be printed in sequence alongside progressively darker reference areas 24 to indicate stages of increased ripeness as indicated by detection of progressively increasing cumulative temperature exposure. Any one, two or more of such phrases, their equivalents or alternatives may be used as may be understood by those skilled in the art in light of this disclosure. If desired, reference areas 24 may be merely adjacent to indicator 16, or otherwise conveniently disposed, rather than being contiguous thereto.

Usefully, the processes and products of the invention include the provision of information or instructions to prospective customers describing the function of indicator 16 and reference ring 18 or areas 24, if employed, to assist the prospect in determining ripeness or maturity of the host product visually. Such information or instructions can be included in label 10, or in another label, or may be incorporated in a package insert or an in-store display, or be otherwise associated with the host product at the point of customer inspection.

The pear 26 shown in FIG. 4 has a ripeness indicating label 10 adhered thereto, prominently displayed on the body of the pear, where indicator 16 incorporated in label 10 can readily be viewed by a prospective customer in a supermarket or other suitable location and where the temperature exposure history of the fleshy body of the pair can be accurately monitored. It will be appreciated that in some instances the body of a pair could be subject to different ripening conditions from the neck. In this embodiment, label 10 does not itself bear descriptive product material, although it may have graphics or text to facilitate proper reading of indicator 16. Instead, a separate product label 27 is disposed on the neck of pear 26 to carry descriptive printed indicia such as were referenced 14 in the FIGS. 1-3. Alternatively, if desired, a composite label 10 such as is shown in FIGS. 1-3, may be employed.

During shipment from the packer, storage and display, each label 10 is exposed to the same temperature-related ripening conditions as its host pear 26 and is accordingly able to give an accurate indication of how those conditions will have affected the ripeness of the pear 26 bearing a particular label 10.

Customers can select pears according to their needs using the visual appearance of indicator 16 to enable them to make the selection visually, even in a case such as an Anjou pear that lacks natural visual ripening cues. For example, for eating immediately, a customer may select a pear having an indicator 16 whose appearance is close to or matches that of reference ring 18. For keeping for a few days, a customer may select a pear 26 whose indicator 16 has a visual appearance indicating that peak ripeness has not yet been reached. With the benefit of a helpful visual ripeness indication specific to the individual pear, many customers will not need to squeeze the necks of numerous pears before making a selection.

Desirably each and every pear 26 in a bulk batch of loose pears bears a ripeness indicator label 10. In another embodiment of the invention, for economy, only a proportion, for example from about 10 to about 50 percent of a batch is labeled. In this case, customers can reasonably extrapolate that a pear adjacent a labeled pear will have a comparable ripeness to the labeled pear. Similarly, in a large tray or crate of product items such as pears, not all, but some strategically located items may be labeled, in a way selected to reasonably sample the ripening indications encountered and provide general indications of more ripeness at the margins of the container, than the middle, for example. However, better customer satisfaction and quality control are believed obtained by labeling every pear 26 or other maturing product item.

Referring now to the embodiment of the invention shown in FIG. 5, a transparent molded plastic container, in the form of a clamshell package 28, contains four pears 26, each having a ripeness-indicating label 10 adhered thereto. As is known in the art, clamshell package 28 can comprise upper and lower portions (not shown) hinged along one side, which cooperatively define four bays 30 each bay 30 accommodating one pear 26. Ventilation holes (not shown) are provided as appropriate to maintain the fruit in good condition. Because the invention does not require retention of volatile agents released from the fruit during ripening, the ventilation holes can have any size and distribution suitable for conditioning the fruit.

If desired, a single one of the pears 26 in the package 28 may bear a ripeness-indicating label 10, serving as the ripeness indicator for all the pears in the package. Alternatively, every pear 26 in clamshell package 28 can bear a label 10, enabling a customer, consumer, or other person to detect differences in ripeness between one pear 26 and another in package 28 that may have arisen and to act accordingly. Thus, the individually labeled pears 26 in clamshell package 28 can be eaten in sequence according to differences in ripeness. For example, the consumer may choose to eat, or use, the ripest pear in the package first and the others in turn as they reach peak ripeness. Such selectivity is not possible if a single indicator is used to indicate the ripeness of all the fruit in a package of multiple items.

Pursuant to one exemplary embodiment of the inventive method for marketing pears, avocadoes, kiwis, mangoes, melons, grapes, tomatoes or other fruits whose ripeness may be difficult to judge by simple visual inspection, are harvested from the orchard, field, vineyard, greenhouse or other growing location, by a fruit packer. The fruit is washed and stored, typically in refrigerated storage, sorted to remove substandard samples, labeled, charged into consumer or display packages, if employed, and packed into shipping containers. These steps can be conducted in known manner.

At an appropriate time prior to, or during this process, the fruit packer receives ripeness indicating labels 10, or the active indicator 16 components of labels 10, from a vendor of same, for example TEMPTIME Corporation, Morris Plains N.J. The labels 10 or indicators 16 are received by the grower in low temperature packaging, e.g. dry ice, and are stored at low temperature, e.g. under temperature conditions in the range of from about −15° C. to about −20° C., to avoid premature activation of indicators 16, until the labels 10, or indicators 16, are applied to the fruit, or fruit packaging. Application of labels 10, or indicators 16, to a host product may be effected at any convenient point in the packer's operations. In one embodiment of the invention, the point or stage in the packer's processing operations when the labels 10 or indicators 16 are applied to the fruit is predetermined, or selected according to the probable ripeness of the fruit to help match the ripeness characteristics of the fruit with the response characteristics of the ripeness indicator.

For example the fruit packer may elect to box or crate the fruit immediately or shortly before shipment and to apply labels 10 or indicators 16 at that point, the labels 10 or indicators 16 being withdrawn from cold storage, or otherwise initiated and, once applied to the fruit, being exposed to the ambient temperature, and other environmental conditions to which the host fruit products are exposed. The fruit that are packed are selected for their degree of ripeness or otherwise have a known degree of ripeness, for example from about 2 to about 10 days short of peak or prime eating ripeness or other suitable degree of maturity. The response characteristics of indicator 16 are matched to the expected ripening performance of the fruit so as to provide a desired color change when a desired degree of ripeness is attained. For example, indicator 16 may exhibit a distinct change from light blue to dark blue, or other distinct visual change, at a point of cumulative temperature exposure judged to provide peak ripeness. Optional use of an orange- or red-colored ultraviolet-protective transparent overlay 20 can provide an essentially gray-scale visual appearance to a blue indicator 16 which appearance changes to a pronounced darker shade, once ripeness conditions have been experienced. Alternative maturity indicators 16 employable in the practice of the invention may, if desired, provide a nonvisual indication, for example an electronic or radio signal, readable locally or remotely. However, visual indications are simple, easily read by consumers and others, require no special equipment and are low cost.

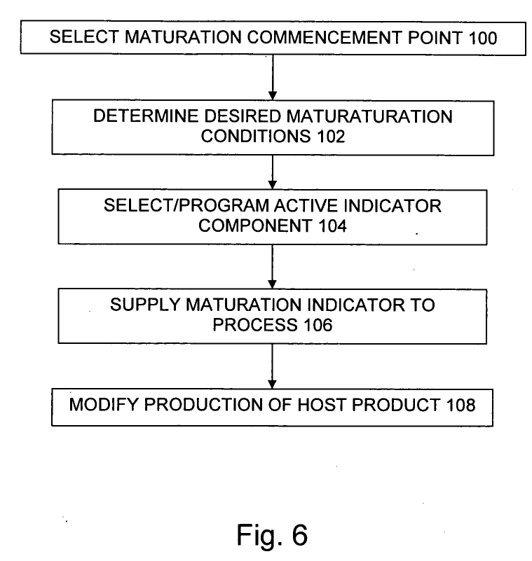

Referring now to FIG. 6, the embodiment of marketing process illustrated begins with the selection of a suitable maturation commencement point, step 100. This step usually will require a good understanding of the processes employed for handling the host product as it matures, ripens or ages, to determine a suitable point in that handling process where the maturity indicator 16 usefully can be initiated. This can be a point where it is convenient to apply to the host product a maturity indicator immediately after it is withdrawn from cold storage, or otherwise activated. It may also be a point prior to anticipated temperature or other environmental fluctuations which may affect the maturation process.

Usefully, the commencement point can be selected to be at the beginning of a quiescent period in the handling of the host product, e.g. a temperature-controlled storage point and after more active handling such as washing, cutting, packaging or other such processing occurs, if such more active handling is employed. As described elsewhere herein, some useful commencement points are the points of entry into a temperature-controlled cooler of fruits, cheeses and freshly slaughtered meat. Other useful commencement points include points of withdrawal from a chiller and entry into a warmer ripening or aging environment which may or may not be temperature-controlled and may be simply the daily ambient environment. Still further useful commencement points will be apparent from the disclosure herein.

In the next step of the process illustrated, step 102, desired maturation conditions are determined. This step comprises a determination of the time-temperature and/or time-humidity conditions, or other environmental condition exposure, to which it is desired to subject the host product from the commencement point to the point of desired maturity. These conditions can be determined in a given case by reference to the maturity and other condition parameters of the host product at the commencement point, to the desired condition of the host product at the indicated maturity point, to what is known about the host product's responses to the applied environmental conditions and possibly to other factors as will be known to those skilled in the art. The maturation conditions from the commencement point to the point of maturity may be as simple as five days at room temperature or quite complex combinations of temperature, humidity, ambient atmospheric composition and the like, as well as multiple stages of different conditions. Many exemplary maturation conditions are described herein. Others will be apparent to those skilled in the art in light of this disclosure.

In step 104 of the illustrated process a suitable active indicator component 104 is selected or programmed. As disclosed herein, a variety of indicator technologies is available from which an indicator 16 can be selected that will respond to the desired maturation conditions selected in step 102 with a recognizable signal signifying that the desired maturation point has been reached. Usefully, conveniently and economically polymerizable acetylenic indicators may be employed to provide a distinct visible indication of maturity. The indicator active agent chemistry may be selected and various adjustments made in its processing or formulation to program in desired response parameters, as is known to those skilled in the art. The response parameters are selected or programmed to match or correspond the response of the active agent to the desired maturation conditions, so that the indicator 16 may be initiated at the point of commencement and provide a clear maturity signal at the desired point of maturity.

In step 106, the appropriately selected and programmed maturity indicator 16 is supplied to the host product handling process and initiated at the previously selected commencement point in that process. For example, a label incorporating the maturity indicator 16 may be withdrawn from a freezer and provided to the host product handling process.

In step 108 the production or handling process for the host product is modified to permit association of maturity indicator 16 with individual items or a batch of host product items at the preselected commencement point. For example, the handling process may be interrupted, or otherwise adapted, while the maturity indicator label 16 is affixed to the host product.

The maturity indicator 16 is now exposed to essentially the same conditions as the host product, responds to those conditions and signals expected maturity of the host product when the preprogrammed conditions have been experienced.

If desired, maturity indicator 16 can be combined in a single label or the like with an RFID, a radio frequency identification device to externally communicate information about the host product item, for example product coding, product description, pricing or the like. A combination RFID tag intended to be associated with a host product and provided with a visually readable environmental condition exposure indicator is disclosed in commonly owned copending U.S. patent application Ser. No. 11/017,534, inventors Jean-Paul MARTIN and Frederick R. GRABINER entitled “RFID Tag With Visual Environmental Condition Monitor” filed Dec. 20, 2004 by Martin and Grabiner, the disclosure of which application is hereby incorporated herein by this specific reference thereto. The present invention also provides a comparable combination tag for use with a maturing host product wherein a maturity indicator as described herein is employed in place of the environmental exposure indicator of the Martin and Grabiner application.

An indicator 16 exhibiting a distinct grayscale change in appearance to indicate ripeness of a fruit is useful not only for fruit such as pears, and other products, whose ripeness may be difficult or impossible to judge visually, but can also be beneficial for people with color-impaired vision, “color blindness” when used with fruit whose ripeness is indicated by a natural color change which is easily judged by most people, for example the green-to-red change of tomatoes and red apples. A significant proportion of males has color-impaired vision and may have difficulty in accurately distinguishing red fruit from green. However a darkened grayscale indicator 16, especially when employed with a suitable reference area 18, can easily be interpreted, even by those with color-impaired vision.

The response characteristics of maturity indicator 16 are correlated or matched with the environmental conditions that are expected to achieve desired ripening of the fruit, for example, a cumulative temperature exposure over time in a maturation range above a base temperature, e.g. above about 5° C., 10° C. or other suitable temperature. The time period may be from about 1 to about 30 days or more, depending upon the fruit and is calculated from a suitable point in the fruit handling process where it is planned to withdraw the maturity indicator 16 from cold storage, or otherwise to initiate maturity indicator 16, and to associate it with a particular piece of fruit or batch of fruit pieces.

The correlation or matching and appropriate selection of active chemical agent for indicator 16 can be effected in any suitable manner, for example, by communication and agreement between the packer and the indicator vendor. In one useful embodiment of the invention, the chemical agent employed in the indicator is programmed by or on behalf of the vendor of the indicator to have response characteristics as desired by the packer. The variables programmed can include cumulative temperature exposure over time sufficient to initiate a discernible visual change, the speed and nature of the visual change, for example the color and color intensity as well as other factors. Such characteristics can be “programmed”, as it were, by suitable selection of chemical indicator agent, by suitable processing of the chemical indicator agent during processing and by other measures as is known to those skilled in the art.

Chemically-based indicator active components such as polymeric diacetylenic color-changing agents are stored at low temperatures and respond more or less gradually, depending upon the particular agent's characteristics, to handling temperatures above freezing at which most consumable products are matured or aged. If desired, a cumulative time-temperature indicator of the threshold type can be employed to monitor possible exposure of a host product to temperatures above a threshold that may cause spoilage. Depending upon their particular characteristics, such threshold indicators can typically be stored indefinitely at or near room temperature. Such threshold indicators are described and claimed in Prusik et al.'s U.S. Pat. Nos. 5,709,472 and 6,042,264 assigned to TEMPTIME Corporation which employ a heat-fusible substance that melts and flows along a wicking strip above a pre-determined temperature, to provide a visual indication of the exposure. Other threshold indicators are known and can be employed in combination with the maturity indicator described herein to provide readily discernible information about both the maturity condition and the quality condition of the host product.

Combination indicators, such for example as are described and claimed in Prusik et al.'s U.S. Pat. No. 5,057,434 also assigned to TEMPTIME Corporation, which integrate a cumulative time temperature indicator and a threshold indicator into a single device may also be employed. Other such combination indicators are known and may be suitable for employment in the present invention, as will be understood by those skilled in the art. For example, Hall U.S. Pat. No. 6,757,492 assigned to Eastman Kodak Company discloses an environmentally sensitive label for use with film that has at least one cumulative time-temperature indicator and at least one thermal event indicator.

Some fruits, for example avocadoes may benefit from a two-stage temperature conditioning process wherein they are stored or at a cooler temperature and ripened at a warmer temperature. A multi-stage indicator can be employed to indicate the maturity of a product exposed to a two-stage conditioning process. Such a multi-stage indicator, which desirably, but not necessarily, is associated with the host product and initiated prior to or during the first, cool-storage stage, can provide two distinct visual changes, one after each display. Two distinct indicator systems each with its own active component can be employed. One is matched to the desired time-temperature maturation characteristics of the first, cool stage providing a visual change when the preprogrammed cumulative temperature exposure has been reached. Similarly, the other indicator system is matched to the desired time-temperature maturation characteristics of the second, warm stage and provides a visual change when the preprogrammed cumulative temperature exposure for that stage has been reached.

Two stage conditioning of fruit, e.g. avocadoes. In one exemplary embodiment of a two-stage process, avocadoes may be initially stored at a cool temperature in the range of from about 2° C. to about 10° C., for a period of from about 2 days to about 12 weeks, and are then ripened at a higher temperature, in the range of from about 15° C. to about 20° C. for a period of from about 1 to about 10 days. In some cases the ripening temperature may be up to about 25° C. for relatively shorter periods, e.g. of from about 1 to about 5 days.

More specific cool storage conditions for the avocadoes which may, for example, be employed comprise a temperature maintained in the range of from about 4° C. to about 6° C. for a period of from about 1 to about 4 weeks.

Model conditions for effective ripening of a particular fruit or batch of fruit or other product can be established depending upon the condition of the fruit, to serve as a basis for selection and/or programming of the maturity indicator active component. In one example of model conditions freshly harvested morphologically mature but unripe avocadoes are determined by inspection to be suitable for storage for 3 weeks at a first stage cool temperature of about 5° C. followed by ripening at a warmer temperature of about 18° C. for about 6 days.

A first maturity indicator 16 employing a polymerizable diacetylenic active agent is selected to have response characteristics matching with, or corresponding, to the model conditions to provide a color change, e.g. distinct darkening, after exposure to the model cool storage temperature and elapse of the determined model cool storage time period. In practice, the indicator, or the active component of the indicator, is withdrawn from cold storage and associated with the avocadoes at the beginning of the cold storage and promptly after harvesting. A color change, or darkening of the indicator indicating cool temperature maturity of the fruit has been reached, occurs after elapse of the model conditions or, as determined by the indicator, after elapse of equivalent conditions. The indicator color change signals that it is time to move the fruit from cool storage to warm ripening. The equivalent conditions may vary significantly from the model conditions while approximating a similar cumulative time temperature value. Similarly, a second indicator with suitable response characteristics is selected for the warm ripening stage, withdrawn from cold storage and associated with the fruit at the commencement of the warm ripening stage to provide a color or other visual change signifying that desired fruit ripeness may have been reached. The first and second indicators can be provided adjacent one another on a suitable label, or otherwise as desired.

Or the maturity indicator could have a response integral which provides a single visual change after exposure to both stages, by averaging. Such a single-response indicator 16 to a two-stage process can, in one embodiment, provide useful compensations in the ripening stage for variations in the cold storage stage. For example, after a longer cold storage period, the single-response indicator can change appearance after a relatively shorter warm ripening period; which would be appropriate for some fruits and other products, reflecting the fact that they may need less ripening at the warmer temperature after longer periods in cold storage.

A suitable active agent for a two-stage averaging maturity indicator 16 intended to be initiated at a point in time during the cooler storage period, for example at the beginning thereof, can be provided having response characteristics which yield a distinct color change, or other visual change after a cumulative temperature exposure which is a sum of the integrals of the degree days for a desired model cool storage temperature exposure and of a desired warm ripening temperature exposure.

Such a two-stage averaged maturity indicator 16 can automatically mimic the avocado fruit's ripening behavior, in an approximate manner, and compensate for longer exposures at the cooler temperature, or for unintended relatively high temperature excursions by, for example by changing its appearance after a shorter time at the higher ripening temperature.

The pears 26, fruit or other consumable product provided with a maturity indicator 16, are then shipped or otherwise transported to a consumer or other customer via the appropriate distribution channel according to the nature of the sale that has been made. Some fruit may be directly marketed using telephone, mail or internet methods for ordering and common carriers such as UPS or the postal service for direct shipment from the grower or packer to the consumer. The ripeness condition of the pears 26 can be selected in relation to the anticipated shipment time so that the fruit arrives in prime condition accompanied by maturity indicator 16. Pursuant to the invention, maturity indicator 16 which has an active agent selected, programmed or tuned to the characteristics of the ripening fruit, provides a clear visual indication to the consumer or other customer that the pears 26 are in a desirable condition of ripeness. This visual confirmation that pears 26 are ready to eat, or are in other desirable condition, enhances the customer's satisfaction with the product and adds value to the product, potentially enabling premium prices to be obtained. Pears 26 with less desirable ripeness indications, can be selected by the customer for immediate eating, if fully ripe, or for additional keeping at a ripening temperature if under-ripe.

Alternatively, pears 26 may be shipped in fulfillment of wholesale sales to a store or to a distributor that distributes to multiple stores, for eventual in-store display and retail sale. To accommodate inventory management needs, and the time needed to display and sell the fruit or other product, the store may prefer to receive the fruit in a ripeness condition which is some days short of peak ripeness. The grower or packer can take this factor into consideration, selecting for wholesale shipment fruit which is somewhat less ripe than is shipped for direct retail sales. The temperature response algorithm of the active agent employed for indicator 16 can be selected accordingly by the indicator vendor to correlate with this lesser ripeness.

Consumers or other customers may then select for purchase from an in-store display, individual fruit 26 or containers such as packages 28 containing multiple pieces of fruit, when indicated as ripe, by indicator 16 or, if the consumer prefers, before a full ripeness indication appears. Easy visual reference to indicator 16 to determine ripeness reduces handling and damage to the fruit and enhances customer satisfaction.

Optionally, indicator 16 may darken beyond a ripeness indication to mark or signal certain fruit as potentially overripe. If desired, store management can employ a severe over-ripeness indication, should such be displayed by maturity indicator 16 to remove overripe pears 26 from the regular display, reducing incidences of customer dissatisfaction arising from arriving home with overripe fruit. Such overripe pears 26 can of course be marked down for quick sale.

It will be appreciated that other fruits and maturing consumable products whose ripeness may be hard to detect can be beneficially marketed as described above for pears, employing a cumulatively temperature responsive indicator 16 optionally embodied in a ripeness-indicating label such as label 10. Some other fruits that may benefit from employment of a ripeness indicator include pears, kiwis, melons, grapes, grapefruit, bananas, peaches, nectarines, plums, pineapples, mangoes, papayas, plantain, avocadoes, tomatoes and other fruits as will be apparent to those skilled in the art. Maturity indicator 16 can be selected to have time and temperature response characteristics that will be appropriate for the various different ripening protocols that are appropriate to each particular fruit according to the knowledge in the respective art about the maturation behavior of a particular fruit or other product, taking into account factors such as the maturity of the fruit when harvested and other factors some of which are mentioned herein.

For example, fully mature bananas and plantains may be matured for periods of from about 1 to about 3 weeks after harvest at temperatures of about 13° C. to about 14° C. Plantains or bananas that are less mature may be matured for longer, for example up to about 8 or 12 weeks. The invention can provide a suitable maturity indicator 16 having response characteristics correlated with these maturation conditions.

Also, plantains and bananas are susceptible to chilling injury. Accordingly, the invention can also provide a low temperature threshold indicator which detects significant unintended low temperature exposures, e.g. 3 hours at 0° C. to additionally provide a visual warning that the fruit may have suffered chilling injury.

Apples and possibly other fruit can be slowly ripened over periods of months, for example from about 3 to about 12 months, at low temperatures near freezing, for example in the range of about −2° C. to about 2° C., enabling a fall crop to be marketed in the following summer. Temperature excursions above the target range will hasten ripening. Thus a maturity indicator 16 can be provided for individual apples or small or large batches, to indicate possibly unexpectedly early maturity before evidence of spoilage becomes apparent, caused by such excess temperature exposure.

Pears can also benefit from a two-stage ripening process and an associated maturity indicator 16 capable of taking account of time-temperature conditions during both stages and indicating maturity accordingly. Some fruits, for example, Beurre Bosc and Doyenne du Cornice varieties of pear may benefit from cold storage before ripening at more elevated temperatures. Suitable ripening conditions are usually also related to the maturity of the fruit when harvested. For example, Beurre Bosc pears may usefully have from about 4 to about 12 weeks of storage at about −0.5° C., followed by a warm ripening period of from about 2 to about 7 days at 20° C. Comparably, Doyenne du Comice pears may benefit from a longer cold storage period of about 8 to about 20 weeks followed by a similar warm ripening period of from about 2 to about 7 days at 20° C. A suitable active agent for an appropriate maturity indicator 16 is selected and/or programmed or tuned to have response characteristics that will take account of both the cold storage period and the warm ripening period and provide an appropriate visual indication of maturity pursuant to the principles described herein.

It will be understood that the particular fruits and conditions described are merely exemplary of the practice of the invention provided to facilitate an understanding of how the practice of the invention can be applied to a wide variety of fruits and other maturing products. Useful equivalents of the various useful time-temperature and other conditions described will be known to or readily apparent to those skilled in the art.

Apples and other fruits, cheeses and the like may also benefit from control of ambient humidity and chemical atmosphere. For example high humidity, around 95%, may be desirable for slow ripening as may variations in the chemical composition of the ambient atmosphere. By way of further example, the atmosphere may be enriched with carbon dioxide, containing e.g. from about 7 to about 25% w/w carbon dioxide, and/or have a low oxygen content, e.g. from about 2 to about 4% w/w oxygen. Hypobaric storage under atmospheric pressures down to about 0.1 atmosphere may also be useful. The invention can additionally employ one or more sensors that respond cumulatively to any one or more of these conditions of humidity atmospheric composition and atmospheric pressure to provide a composite or combination indication of maturity that takes account of these factors in a manner which effectively models the product maturation process.

As mentioned above, some fruits, for example avocadoes and pears, may benefit from a two-stage conditioning or ripening process wherein the fruit is stored at a lower temperature in a first stage, for example a temperature in the range of from about −2° C. to about 10° C. followed by ripening at a higher temperature, for example in the range of about 10° C. to about 25° C. The invention can provide a suitable maturity indicator 16 tailored to provide dual stage maturation monitoring of any desired fruit, pursuant to the principles described herein for avocadoes.

For example, kiwi fruits may ripen in about 2-3 days at 20° C. after five or more weeks of storage at temperatures near to 0° C., or after ethylene treatment employing an external source of ethylene distinct from any ethylene that may be generated by the fruit itself. This ripening period may increase to about 4-6 days where the cold storage temperature is shorter and there is no ethylene treatment. Mature green guavas may be held at about 2-3 weeks at about 5° C. to 10° C. and may then be shelf stored for up to about 7 days at about 20° C.

Other fruits, for example dates, and other products, for example cheddar cheese, discussed in detail below, may have several different maturities providing a range of products of different market-recognized character. Dates are known to have three distinct maturation levels: sweet khalal when the fruit starts to turn yellow or red; rutab when the tips of the fruit start to turn brown; and tamar when the dates are completely brown. Pursuant to the invention maturity indicators 16 can be provided for any one or more of these stages. Such maturity indicators may include one or more reference areas 24 corresponding with one or more maturity stages. In one embodiment of the invention, three reference areas 24 are provided, with appropriate textual, graphical indications or both, with different visual appearances corresponding with the three maturity stages, in the case of dates, sweet khalal, rutab and tamar.

Some suitable non-fruit consumable products that may benefit from application of a ripeness or maturity indicator include cheeses, aged meats, wines, whiskies and other beverages that can benefit from maturation.

Many cheeses benefit from several weeks or months of maturation. Use of a ripeness indicator as described herein can give a customer confidence that a cheese has been properly ripened. If desired, multiple ripeness stages may be identified, by appropriate correlation of the indicator active agent response characteristics with different labeled reference areas such as are described in connection with FIG. 3. For example, a soft cheese such as a brie may have ripeness stages identified as “firm”, “softening”, “soft” and “strong flavored” correlated with different, increasing, cumulative temperature exposures, as detected by the ripeness indicator. In another example, a hard cheese such as a cheddar may be described as “mild”, “sharp” or “extra sharp” correlated with different, increasing, cumulative temperature exposures, as detected by the ripeness indicator. Other useful embodiments employing the inventive ripeness indicator applied directly to a cheese, or cheese portion, or to its packaging, will be apparent to those skilled in the art.

The inventive ripeness indicators can also be beneficially employed to indicate the maturity or drinkability of wines, especially vintage wines. Many of the best wines, for example quality Bordeaux, sometimes called “claret”, burgundy, port, champagne and other quality white wines may require years of storage to attain good or optimum quality. While vintage charts and other maturation guides are available to help consumers, restaurateurs and others to judge the quality of an unopened bottle of wine, such charts usually describe maturity in years and assume constant or stable temperature conditions at some optimal or recommended temperature. In practice, much wine is not stored under temperature controlled conditions and is likely to experience substantial exposure to temperatures above the recommended temperature which may mature the wine more rapidly than vintage charts suggest.

To solve this problem, the invention provides bottled wine intended for keeping while the wine matures, which wine may for example be a wine as described above, having affixed thereto a maturity indicator label, for example label 10. which monitors cumulative temperature exposures and provides a visual indication of one or more temperature exposures that is believed to correlate with a maturity stage of the wine. Optionally, the wine maturity label can be placed on the sloping shoulders of the bottle, or possibly on the neck, for easy visibility when the bottle is stored in a prone position in a wine rack or equivalent.

If desired, a threshold indicator or a combination indicator, such as is described hereinabove, may also be employed to alert the viewer to possible exposure of the wine to damaging temperatures that may have impaired its quality.

The wine maturity indicator label can, if desired, have a reference area 18 or multiple reference areas such as 24 to help read the indicator, which areas may be marked with phrases such as “still maturing”, “nearly ready”, “mature” and “drink now.” By suitable selection or programming of an active agent or active agents employed for the wine maturity indicator, the indicator's appearance change, or changes, resulting from cumulative temperature exposures can be correlated with the various predicted maturity stages.

Suitable indicators or indicator labels, correlated to the wine's expected maturity characteristics may be withdrawn from cold storage and applied to the wine bottles, or possibly, barrels, jugs, pipes or other wine containers, at any suitable point in time for example when the wine is bottled, or labeled or leaves the vintner, or even when a new estimate of maturity has been made for a wine that has already been maturing for some time. It will be appreciated that the inventive maturity indicators can be employed to indicate intermediate stages of maturity, serving to monitor cumulative temperature exposures, for example of barrels of port held for late bottling. The bottling process may be timed in accordance with a visual maturity indication made pursuant to the invention which indicates that the wine is ready for bottling, albeit not yet ready for drinking.

The predicted wine maturity period, from application of the inventive maturity indicator to a visual change indicative of a useful maturity stage may be any useful interval is known in the art, for example from one to thirty or even fifty years for a number of specialty wines. Intervals of from two to ten or twenty years may be adequate for many wines. Maturation temperatures may vary but are typically in the range of from about 5° C. to about 25° C.

Some embodiments of the invention can provide indicators employing active agents having corresponding response characteristics.

By employing the inventive maturity indicator, unusual elevated temperature exposures, such as may occur, for example, during a hot summer, or as a result of equipment failures, or artificial heating systems, are factored into the maturity indication, enabling a wine consumer to know, for example, that their particular wine stock is maturing earlier than a standard vintage table might suggest. The consumer may enjoy the wine earlier, and possibly avoid keeping it in accordance with the recommendations of a vintage wine chart only to find the wine is “over the top”, i.e. has aged past its best because the summer heat has accelerated the aging processes. Alternatively, where the wine is exposed to cooler temperatures than are desirable, possibly as a result of winter weather or equipment failures, the aging process may be slowed and the maturity or drinkability stages may be delayed in time beyond what is indicated in a standard vintage table, the inventive maturity indicator will have a correspondingly delayed visual change enabling consumption of the wine to be delayed to a later point in time than might have been suggested by the standard vintage table.

It will be understood that other maturing beverages, for example whisky, brandy sake and so on can similarly benefit from employment of the maturity indicator features of this embodiment of the invention or from being marketed with a maturity indicator pursuant to the invention.

Aged meats such as steak may similarly benefit from the described maturity indicating features of the invention and will generally have maturity intervals measured in weeks or perhaps months with corresponding indicator response times.

Other maturing consumable products which can benefit from use of a ripeness or maturity indicator according to the invention will be apparent to those skilled in the art from the disclosure herein and include other maturing foodstuffs additional to those described, other consumable biological products, consumable products having nutritive value, as well as other beverages or drinks. Some examples illustrating the diversity of consumable products which may be employed in practicing the invention are fruit cakes and “plum” puddings, also known as Christmas cakes and Christmas puddings, which in some cases may be considered to improve in quality after keeping for some months or even a year or two.

The invention extends to any novel product described herein including: a maturing consumable product provided with a maturity indicator 16 or label 10 associated with the host consumable product or having the indicator or label adhered or otherwise affixed thereto; loose, individually ripeness-labeled products; and packaged products having individual ripeness indicators or a package ripeness indicator.

The chemical active agent employed by indicator 16 may be incorporated in an ink or be otherwise employed and may comprise a suitable compound or compounds as is known to those skilled in the art. Suitable compounds include a polyacetylenic active agent which provides a visual response to environmental exposure to temperature, moisture, or other targeted environmental condition. Some useful polyacetylenic active agents include substituted diacetylenic agents such, for example, as: 2,4-hexadiyn-1,6-bis (ethylurea), also known as “KE monomer”; 2,4-hexadiyn-1,6-bis (propylurea) also known as “KPr monomer”; and co-crystallized acetylenic agents, such as a 2:1 co-crystallized mixture of the KE and KPr monomers, which mixture is also known as “KX monomer”.

Other polyacetylenic agents may be employed as is known, for example, from Patel U.S. Pat. Nos. 4,189,399 and 4,384,980 and Preziosi et al. U.S. Pat. Nos. 4,789,637 and 4,788,151. The disclosure of each one of the aforementioned Patel and Preziosi patents is hereby incorporated herein by this specific reference thereto. Those skilled in the art will understand modifications that may be made to such agents including broad ranges of substituents that may be made and complexes in which they may be incorporated, as well as methods of synthesis and blending and co-crystallization operations that may be employed to provide visually active condition-sensing agents useful in the practice of the present invention.

Visual indicator 16 may, with advantage, be a visual indicator supplied, by TEMPTIME Corporation, Morris Plains, N.J., as a time-temperature indicator which provides a color change after a given degree day or degree hour exposure of the indicator and provides a cumulative indication of temperature fluctuations over time. Such indicators can reliably measure the integral of multiple temperature excursions above a baseline of various durations.

It will be understood that the consumer product unit can comprise an individual consumer product item, piece or portion, the item piece or portion optionally being wrapped, a package, box, tray, crate or other carton containing multiple individual consumer product items, pieces or portions of a consumable product or a container containing a plurality of said boxes, trays, crates or cartons.

Various visual environmental condition indicators may be employed in the practice of the invention. For example, the visual environmental condition indicator may be responsive to an environmental condition selected from the group consisting of: cumulative temperature exposure over time; cumulative humidity exposure over time; cumulative concentration exposure over time to a maturity-affecting externally applied gaseous agent; cumulative concentration exposure over time of a carbon-dioxide sensitive consumable product to externally applied carbon dioxide; and cumulative concentration exposure over time of apples, pears, or other suitably responsive fruit, to externally applied ethylene.

Where gaseous agents such as ethylene or carbon dioxide are monitored it is to be understood that these agents are components of an applied artificial atmosphere providing desired maturation conditions whose character over time is monitored. An algorithm which takes into account known information about the maturation behavior of the host product is used to predict the elapse of conditions that usually provide maturation to select an active element that will respond to the prevailing applied atmosphere, temperature, humidity or other environmental condition or conditions with a distinct visual change, or other signal, to indicate a sufficiency of maturation conditions has occurred. Unlike the Jenkins or Pear Bureau product which relies upon detection of agents released from the pears, the present invention looks to the conditions experienced by the host product rather than to the actual behavior of the host product.

Aged Beef Maturity Monitoring. Another class of maturing consumable product which can benefit from the marketing method of the invention comprises aged beef, especially steak, and other meat products, for example certain gourmet hams, sausages and the like. The invention can also be beneficially applied to indicate the maturity of such aged beef, or other maturable meat products and includes such aging meat products provided with a maturity indicator.

Some primal or wholesale beef cuts which may be aged and employed in the practice of the present invention include whole beef, side beef, quarter beef, and other primal cuts as well as chuck, shank, brisket, rib, short plate, loin, flank and round. Some retail cuts of beef that may be similarly employed include boneless top loin steak, porterhouse steak, t-bone steak, tenderloin roast, tenderloin steak, New York strip steak, sirloin, sirloin steak, pre-packed roasts, steaks. Any suitable grade of beef may be utilized, including premium quality and government graded beef such as USDA choice and premium grades, beef certified as AAA by the Canadian Beef Grading Agency and certified organic beef.

Aging is a natural process that may improve not only the tenderness, but also the flavor of beef, especially in cuts from the rib and loin such as rib, ribeye, porterhouse, T-Bone, top loin, sirloin and tenderloin steaks.

Aging allows the natural enzymes in beef to tenderize the meat by breaking down specific proteins (connective tissue) in muscle fibers. Most of the tenderization usually occurs within the first 7 to 10 days of aging, although a small increase in tenderness may occur after 7 to 10 days.

Two types of aging are practiced commercially: dry and wet aging and the invention can usefully be applied to the products of either process.

In dry aging an entire carcass or wholesale cut, without covering or packaging, is placed in a refrigerated room at about 0° C. to about 2° C. under humidity controlled conditions for up to about 28 days. Too much humidity allows excessive microbial growth; too little causes excessive shrinkage. If the temperature gets too high, microbial growth increases significantly. During properly controlled dry aging, beef usually loses moisture. The dry aging process also adds flavor to beef, often described as “brown-roasted beefy flavor.” Prior to this invention, much dry aging in the United States is done by upscale steakhouses and specialty beef purveyors.

Wet aging refers to the aging of beef in vacuum bags under refrigerated conditions of about 0° C. to about 2° C. Humidity control is not necessary for wet aging as the beef is tightly sealed in the packaging. Because most beef is vacuum packaged at the site of carcass cutting, wet aging is often a preferred method of aging. By the time the vacuum-packaged beef reaches the retail store, at least 7 to 10 days, the time needed for much of the tenderization to occur have usually elapsed. However, additional tenderization may occur with longer aging.

A desired maturity of the aging beef may be monitored and indicated by use of an appropriate active time-temperature indicator and by initiating its active component at a suitable point in the maturation process. To this end, one embodiment of the invention comprises a time-temperature indicator having response characteristics such as to provide a distinctive visual change, for example darkening, after a cumulative temperature exposure sufficient to bring the aging meat to a desired maturity may be selected as the maturity indicator. The performance characteristics of the time-temperature indicator may be programmed or tuned by appropriate selection of its active component and by chemically, or otherwise, controlling or modifying the characteristics of the active component, as is known in the art.

Thus, for example, desirable beef aging characteristics may be determined to be from about 3 to about 30 days at a temperature in the range of from about 1° C. to about 4° C. from the time the carcass or beef cut enters a chiller. Other temperatures may be employed, if desired, as is known in the art, for example a temperature in the range from about 0° C. to about 10° C.

Other time-temperature aging characteristics may of course be chosen, notably for example, different customers may desire different aging periods, e.g. 7, 10, 14 or 28 days. Also, different cuts or configurations of beef may benefit from different aging periods, with larger masses of beef requiring somewhat longer aging to develop a desired flavor. For example, rib and loin cuts may benefit from a minimum of 14 days for aging; tender-loins a minimum of 7 days; sirloins a minimum of 21 days or even 28 days; and chucks and rounds a minimum of 7 days. The invention includes maturity indicators and maturing meat products and marketing methods employing such maturity indicators, that are selected, programmed or tuned to have response characteristics adapted to any of the above described desirable meat aging conditions.

Pursuant to the invention at the commencement of the aging process a time-temperature indicator, or label or the like bearing it, which time-temperature indicator has response characteristics in the aging range, is initiated, for example by withdrawing the time-temperature indicator from low-temperature storage, e.g. in the case of a polymeric agent indicator in a freezer maintained at a temperature below about −15° C., or lower, for example at about −20° C., and is associated with the aging beef. For example, the time temperature indicator may be affixed to a packaged or unpackaged cut of beef as the meat is introduced into the aging chamber or chiller.

The maturity indicator can be chemically programmed to have a visible opto-chemical response selected to comprise for example a visually distinct change, such as a color change or darkening, after removal from low temperature dormant storage, and after a baseline time-temperature exposure of say about 21 days at approximately 2° C. Employing a time-temperature indicator exhibiting a cumulative response, for example as are available from TEMPTIME Corp., Morris Plains, N.J., the indicator may show its visual change somewhat later than or earlier than the baseline 21 days, if the temperature of the cold room or other aging chamber fluctuates significantly. For example, if the temperature of the cold room should run a few degrees higher than planned for a number of days, or if a particular piece of beef should be in a location that is warmer, or colder than the location of a climate control temperature sensor in the cold room, the inventive maturity indicator can automatically compensate for such temperature anomalies. The maturity indicator of the invention can give the cold room manager a visual alert that its host beef product may be adequately aged prior to elapse of the baseline exposure period as a result of exposure to higher temperatures than the baseline. Alternatively, the maturity indicator by having not changed, or by displaying only a weak visual change, may provide a visual alert that its host beef product has not received adequate temperature exposure to attain maturity.

The maturity indicator desirably is provided with at least one reference marking, preferably adjacent the active indicator area, to show a viewer that the desired aging exposure has been reached when the active area appearance matches the reference marking. When, or shortly before, the aging beef reaches this desired maturity, a manager of the aging process can take steps to deliver the cut of beef, or a portion thereof to an end user, for example a consumer or restaurant.

If desired, the delivery management process can be facilitated by providing an additional reference marking, e.g. in a lighter shade or tint than the full maturity reference mark, corresponding with a time-temperature exposure that is say 1 to 5 days short of what is appropriate for peak or desired maturity. The second reference marking can be used to provide an early warning indication that it is time to ship the beef product if it is to reach the customer at the desired maturity.

In another embodiment of the invention for indicating the maturity of beef a temperature-responsive maturity indicator is initiated and associated with the beef prior to admission of the beef to the aging chamber at a predetermined point in the process of preparation of the beef between slaughter and commencement of aging. In this case, the response characteristics of the active component of the maturity indicator are selected to accommodate the anticipated time-temperature exposure prior to aging. It will be understood that, because of the risk of spoilage, good control and careful monitoring of the aging process is desirable.

The predetermined point in the process may be at any suitable stage in the process for example promptly after slaughter, promptly after hide and entrail removal, at a suitable point in the cutting and trimming room, or at any other suitable point. Pursuant to the invention, any undue or unintended temperature exposure of the beef subsequent to indication of the maturity indicator, whether during aging or during the preparatory process, is also experienced by the maturity indicator which will respond accordingly.

For example the beef may be exposed to temperature excesses as a result of equipment failure or a summer heat wave. Or there may be processing delays between slaughter and commencement of the aging process arising from improper handling, backlogs or other factors.

In effect, the maturity indicator compensates for the undesired or unintended exposure by changing its appearance at an earlier point in time to suggest a reduced aging period for the associated beef cut or carcass. In this way, the maturity indicator of the invention can be helpful to quality control processes, for example by avoiding delivery of spoiled or overly aged beef to customers.

If desired, for use with larger, more valuable cuts of beef, or whole carcasses or sides of beef relatively larger area maturity indicators may be employed for better visibility in the aging chamber or elsewhere.

By way of example, during commercial beef production, a meat processing line moves an animal through slaughtering and the resultant carcass through a number of stages prior to cold storage. In a typical case the animal is stunned then bled. Next, the hide is removed. The resultant carcass is prewashed, the viscera are removed and the carcass is split into two halves at this or another suitable point in the process. The carcass is inspected, weighed on a scale and washed. After washing the carcass is delivered to a chill room for storage and cooling prior to further processing. Other processes, such as trimming and removal of certain portions of the carcass, may also typically be carried out before chilling of the carcass. Such further processing may, for example include butchery of the half carcasses into desired cuts, packaging of the meat for distribution and consumption and optionally, wet or dry aging of the carcass or cuts.

In the U.S. an inspection of every carcass is typically performed at inspection stations located adjacent to or along the meat processing line by a government entity, such as the United States Department of Agriculture (“USDA”).

The invention includes process embodiments wherein the inventive maturity indicator can be withdrawn from freeze storage, or otherwise initiated, and associated with a carcass or cut at any desired one of the above-mentioned beef-processing stages, or other desired point in the process, for example by being affixed to the carcass or cut. The response parameters of the maturity indicator's active component are selected according to the particular point in the process where the indicator is to be initiated and associated with a specific beef carcass, cut or other product so as to provide a visual maturity indication after the beef product has experienced an appropriate time-temperature exposure during processing and aging. This method can also be applied to “ordinary” beef which is not destined to be described as aged, to provide a beef quality condition indicator.

If desired, the maturity indicator can have an additional visual reference area or other suitable informational device facilitating determination that the beef product has reached its safe limit and should be consumed immediately, which is of course correlated with an expected visual change in the active visual area, for example by being darker than an indication of maturity. Information as to an exposure associated with spoilage or an unsafe condition can also be indicated, if desired, by providing an additional reference area having a visual appearance corresponding with that acquired by the active component of the maturity indicator after an excess condition exposure anticipated as being such as to cause spoilage of, or an unsafe condition in, the host beef product prior to consumption. Such an indicator can be included in a quality control label or indicator system or in a quality control or inspection method to prevent delivery of spoiled or unsafe beef to customers, supermarkets or others downstream from the beef processor. For example in a beef processing quality control or inspection method employing such a spoilage indicator, at a suitable inspection point in the delivery chain, human technician or suitable automated reading device, can inspect the maturity indicator causing differential treatment to be given to host beef products exhibiting an indication suggestive of spoilage exposure, either at the point of inspection or by the time the host product reaches a point of consumption or other appropriate point in the distribution chain. For example, the suspect product can be diverted to a lower grade value use, if such exists, or removed from the production line and destroyed.

It will be appreciated that an inspection process using a visual spoilage indicator responsive to the temperature history or other relevant conditions of the host beef product, such as is described above, is well suited to adoption by and incorporation in an official inspection program intended to protect consumers, and could, with advantage, be employed by government inspection programs, for example, programs administered by the USDA.

If desired, embodiments of the inventive processes may employ scanning or optical reading devices to read the maturity indicators 16 of host product items as the items are handled commercially by a grower, packer, distributor, supermarket or the like, while the same device that is machine read can provide a distinct visual indication of maturity to the human eye of a retail or other customer, enabling the customer to quickly make a determination, with ease and without special equipment.

It will be understood by one skilled in the art that the above-described maturity indicators and maturation management processes can be applied, with little, if any, modification, as will be apparent, to the processing and labeling of other meats and meat products, for example veal, pork, chicken, lamb and goat meat and to products embodying those meats including sausages and the like. In many cases, aging may be undesired or minimal and the methods and products of the invention can be adjusted accordingly to indicate, or not indicate an aging period, as is desired.

Other Aged Meat Products. The meat maturity applications of the invention are also of value for certain gourmet or specialty meat products which may be aged to provide a higher value product. Some such examples include certain sausages, gourmet hams, pheasant, jugged hare and other gourmet game products. For example, gourmet hams may be salted and aged at a suitable temperature in the range of from about 0° C. to about 5° C. for periods of from about 3 to about 15 months and in one useful embodiment of the invention in the range of from about 9 to about 12 months. Such a gourmet ham product is offered by Aoste at www.festivalsaoste.com. Other suitable aged meat products which can benefit from the methods, devices and systems of the invention will be known to or apparent to, those skilled in the art.

For example, air dried and aged sausages are a popular product in certain European countries and are also available in the U.S. In one embodiment of such an aging process, sausages, for example gourmet sausages supplied by Aoste, are aged for a period of from about 60 to about 70 days at a temperature of from about 18 to about 22° C., as an example. The sausage can be distributed to retailers or others at or near ambient temp and can be displayed in an uncontrolled environment at a shop or other retail outlet. The aging period and temperature consequent degree of maturity may be varied according to consumer preference. Possible ranges of conditions include from about 20 to about 120 days at temperatures of from about 15 to about 30° C. Customers may buy sausages ready to eat or to further keep at home in the refrigerator or to leave at room temp, as they may prefer.

The invention may be applied to indicate the maturity condition of such sausages and other aged meat products following the principles described hereinabove for aged beef. Optionally, a maturity indicator for air matured sausages may have multiple reference areas indicating multiple visual changes corresponding with different maturities. Optionally also, a spoilage indicator may be included, if desired.

Cheddar Cheese Maturity Indicator As has been referenced herein, the invention can usefully be employed to indicate the maturity or maturity of cheese. Some embodiments of such cheese applications will now be described, referring to cheddar, a ubiquitous cheese, by way of easily understood example. It will be understood, that the invention is similarly applicable to provide maturity indications for most cheeses and especially for premium and gourmet higher value cheeses, for example, camembert, gruyere and Roquefort and other cheeses some of which are mentioned hereinbelow, that require a distinct ripening process to attain peak condition.

Referring now to the application of the invention to cheddar, the invention includes, as an article of commerce, a cheddar cheese or cheese piece labeled with a cheddar cheese character descriptor, e.g. “mild”, “sharp” and/or “extra sharp” and which is provided with a maturity indicator, as described herein. The maturity indicator can be coordinated with the host cheddar or cheddar piece, to provide a distinct visual change when the host cheese product has experienced adequate time-temperature exposure to ripen to the desired quality characteristic. Coordination can be effected by selecting an indicator to have response characteristics corresponding with the desired cheese maturation period and initiating the maturity indicator at the start of the cheese ripening process or at another suitable point. An instruction can be associated with such a cheese product, or other host product item as described herein, communicating that the product is mature or ripe when the indicator has a changed visual appearance. The changed visual appearance may be described textually on the package or an adjacent display, as, being e.g. “dark”, “blue” or “dark blue”. However, some desirable embodiments of the invention comprise alone, or accompanied by descriptive text, graphics, or other indicia, one or more reference indicators having the desired visual appearance of a maturity indication. The reference indicator is preferably disposed adjacent to or contiguous with the active visual indicator which relates the time-temperature exposure of the cheese to the character descriptor.

Thus, in one embodiment of the invention, a given cheddar cheese product may, for example, be categorized as a mild cheese and the maturity indicator may be selected to indicate a suitable time-temperature exposure to achieve the desired maturity for a mild cheddar. One example of a suitable time-temperature exposure for a mild cheddar is an exposure to a ripening temperature of from about 6° C. to about 8° C. for a period of from about two to about nine months for example a period of about three to about six months. If the cheese ripens beyond the desired maturity for mild cheddar, the flavor may be too strong for some customers. On the other hand, if there is inadequate maturation, the cheese may be unacceptably bland and tasteless. Such difficulties may be avoided by employing a maturity indicator in accordance with the invention.

Similarly a cheese may be categorized as a sharp cheese and the maturity indicator may be selected to provide a distinct visible change after exposure to a similar ripening temperature for a period in the range of from about nine to about eighteen months, for example, a period of about twelve to about fifteen months. An extra sharp cheddar can similarly employ a maturity indicator selected to provide a maturity indication of from about twelve to about 24 months or even more, for example from about eighteen months, or more. In each case the maturity indicator is selected to have a response profile corresponding with the desired maturation algorithm, for example by suitable choice of the active agent employed, to provide a distinct visual change, for example a color change approximately at the point of maturity.

The maturity indicator can be initiated in any desired manner, for example, in the case of a polymerization reaction indicator by removal of the indicator or an active element thereof from cold storage, e.g. freezer storage at a temperature of −15 or −20° C. or below. The maturity indicator is then promptly associated with a desired host cheese piece whose maturation is to be monitored, for example by being affixed thereto. Other types of indicator can be initiated in suitable manner, e.g. by removal of a release sheet and engagement of the resultant exposed surface with a cooperative component of the indicator. The response parameters of the maturity indicator's active component are selected according to the particular point in the cheese piece maturation process where the respective maturation indicator is to be initiated or affixed so as to provide a visual indication of probable maturity after the cheese item has experienced a desired time-temperature exposure.

It will be understood that the ripening process accelerates at higher temperatures, and slows at lower temperatures. The time-temperature indicators described herein respond in a similar manner, giving a visual indication of cumulative time-temperature exposure, to provide an accurate maturity indication, notwithstanding fluctuations in the temperature of the environment experienced by the cheese, of equivalents of desired maturation conditions.

Retail customers in a store may prefer products displaying a visual maturity indicator and may be willing to pay a premium for them. The customer can select a cheese product bearing a visual indication that it has reached maturity or has other suitable maturity condition desired by the customer, with a reasonable expectation that the cheese will have a desired flavor and condition. Cheese pieces whose indicator has not yet changed to give a visual maturity indication may be left in the display case to ripen further. If desired, mild cheese pieces that have a visual indication from the maturity indicator that they are past their peak maturity may be kept longer to mature into a sharper cheddar and relabeled accordingly by the store or other vendor.

Exposure to an unduly elevated temperature, for example in the case of a cheddar, a temperature of at least about 20° C., for a significant period, for example a minimum of from about six to about 48 hours, may cause undesired microbiological growth to occur, impairing the quality of the cheese product.

If desired, a cheese maturity indicator according to the invention can also include a spoilage or “past-peak-maturity” indicator comparable with that described for beef hereinabove. Such a spoilage indicator can facilitate a determination that the cheese product has reached a quality limit and should be consumed promptly.

Other Cheeses. The invention can be applied to market, or indicate the maturity of, other cheeses in similar, or corresponding, ways to what has been described above for cheddar. Maturity indicators tailored to the particular characteristics of other cheeses can be provided and affixed to or otherwise associated with pieces or containers of such other cheeses.

There is no particular limit to the nature or style of the cheeses with which the invention may be beneficially employed. If a cheese requires or benefits from a maturation period measured in days or longer and the cheese has commercial value, it is a candidate for beneficial application of the invention. Thus mammal's milk cheeses made from the milk of cows, goats, sheep, mares, yaks, camels or other suitable mammals, may be utilized as also may maturable cheeses made from soy or other vegetable products. Cheeses in any desired style such as soft, semi-soft, hard, crumbly, creamy, blue, and so on as is known in the art, can be employed.

Some cheeses which may be beneficially employed in the practice of the invention or to which the invention may be applied, and useful maturation conditions for such cheeses are set forth in Table 1 below:

TABLE 1
Cheese Maturation Periods

| | | MATURATION | | MATURATION | |
|---|---|---|---|---|---|
| CHEESE | STYLE | TEMPERATURE | | PERIOD/STYLE | |
| Asiago | fresh | 10-20° | C. | 2 | months |
| | medium | | | 6 | months |
| | old | | | 12 | months |
| Bel Paese | | 10-20° | C. | 5-8 | weeks |
| Blue | mild | 10-15° | C. | 2 | months |
| | average quality | | | 3-6 | months |
| | better quality | | | 9 | months |
| Brick | | 10-20° | C. | 2 | months |
| Brie | | 10-15° | C. | 4-8 | weeks |
| Caciocavallo | table | 10-20° | C. | 3 | months |
| | grating | | | 12 | months |
| Camembert | | 10-15° | C. | 4-6 | weeks |
| Cheddar | mild | 6-8° | C. | 2 | months |
| | sharp | | | 3-9 | months |
| | extra sharp | | | 12 | months |
| Colby | | 10-20° | C. | 1-3 | months |
| Emmental (Swiss) | regular | about 12-14° | C. | 2-4 | weeks |
| | | and then 20-24° | C. | 2-4 | weeks |
| | premium | about 12-14° | C. | 2-12 | months additional |
| Edam | | 10-15° | C. | 2 | months |
| Gorgonzola | mild | 10-15° | C. | 3 | months |
| | premium | | | 6-12 | months |
| Gouda | | 10-15° | C. | 2-6 | months |
| Gruyere | | 10-20° | C. | 3 | months |
| Limburger | | 10-20° | C. | 1-2 | months |
| Monterey Jack | table | 10-20° | C. | 2-8 | weeks |
| | grating | | | 6 | months |
| Parmesan | | 10-20° | C. | 10 | months |
| Port du Salut | | 10-20° | C. | 6-8 | weeks |
| Provolone | | 10-20° | C. | 6-15 | months |
| Romano | table | 10-20° | C. | 5-10 | months |
| | grating | | | 12 | months |
| Roquefort | mild | 10-15° | C. | 2 | months |
| | premium | | | 2-6 | months |
| Sapsago | | 10-20° | C. | 5 | months |
| Stilton | | 10-15° | C. | 4-6 | months |
| Swiss (Ementhaler) | mild | 10-20° | C. | 2 | months |
| | premium | | | 2-9 | months |

The maturation period can be understood to be a minimum unless a range is given. The maturation periods are approximate and longer maturation periods may be employed, according to taste, subject to avoiding spoilage and to economic considerations. The data in Table 1 is to be understood to be merely exemplary of maturable cheeses, cheese styles and possible cheese maturation periods and temperatures that are known to those skilled in the art and that may be employed in the practice of the invention. Accordingly, the temperatures and durations shown in Table 1 may be widely varied, if desired. In some cases, ripening may be accelerated by increasing the ripening or maturation temperature.

Any of the cheeses in Table 1, or other suitable cheeses, may be employed in the methods and products of the invention, such as those described hereinabove for cheddar cheese, with suitable modifications of conditions or the like, as will be apparent in light of this disclosure. As indicated in Table 1, and additionally as is known in the art, some cheeses may be aged in two or more stages. For such cheeses, the invention can provide two-stage or multi-stage maturity indicators which may provide separate responses and indications for the separate stages, or may provide an averaged response with a single maturity indication for two or more stages, as described hereinabove.

Cheeses such as soft cheeses that require high humidity during maturation to avoid drying may employ a combination maturation/humidity indicator, if desired.

In the foregoing description, particular reference has been made to the use of maturity indicators employing color- or reflectivity-changing chemical polymerization-based active agents as a wide range of suitable such active agents is known and effective and are commercially available at low cost, e.g. from the assignee hereof, TEMPTIME Corporation, Morris Plains, N.J. Some indicators utilizing such technology which may be employed in the practice of the invention are disclosed in Patel U.S. Pat. Nos. 5,254,473; 5,053,339 and 5,045,283, the disclosure of each of which patents is hereby incorporated herein by this specific reference thereto.

Alternatively, a variety of other indicator technologies are available and can be employed, if desired, as will be apparent to those skilled in the art. For example, diffusion technology such as is disclosed in a number of patent publications assigned to 3M Innovative Properties Company, for example Arens U.S. Pat. No. 5,667,303; Spevacek U.S. Pat. No. 6,614,728; Bommarito, et al. U.S. Pat. No. 6,741,523; Spevacek US Patent Publication No. 20030053377; and others may be employed.

Thus, for example, Arens et al. discloses time-temperature indicators, some of which require mechanical activation, that employ the migration or diffusion of a viscoelastic material, e.g. an adhesive into a substrate to change the light transmissivity of the substrate, to provide an indication of the expiry of the useful life of perishable products such as foods, food additives such as aspartame, biological materials, drugs, cosmetics, photographic supplies, and vaccines.

Some other monitoring technologies that may be employed in the practice of the present invention are described in the following paragraphs. Others will be apparent to those skilled in the art.

Yanagi, et al U.S. Pat. No. 5,756,356 assigned to Toyo Ink discloses a method of indicating a temperature-time accumulated value as a color change wherein an oxidation-polymerizable dyestuff and an oxidizing agent are brought into contact with each other.

Lupton et al. U.S. Pat. No. 5,622,137 assigned to Trans World Services discloses use of a colored thermochromic material obscuring a patch of another color, that melts and becomes transparent when exposed to a predetermined temperature. Lupton et al. lists a number of patents and other publications describing time-temperature indicators, which listing is hereby incorporated herein along with the disclosures of each patent or other publication listed by Lupton et al. Each patent here mentioned is hereby incorporated herein by reference, such incorporation by reference herein being emphasized in the statement to that effect at the end of this specification.

Manico et al. U.S. Pat. No. 6,043,021 assigned to Eastman Kodak Company discloses a time and temperature integrating indicator device having a thermally sensitive image-forming area which comprises a combination of an organic silver salt oxidizing agent and a reducing agent monitoring thermal exposure of photographic material. As well as the combination indicator disclosed in U.S. Pat. No. 6,757,492, described above, other patents assigned to Eastman Kodak Company, for example U.S. Pat. Nos. 6,514,462; 6,214,623; and 6,113,857, disclose various time-temperature and other condition monitoring indicators that may be useful in the practice of the present invention.

FreshPoint Quality Assurance Ltd. discloses on their web site possible use of a time temperature indicator to provide a visual reading of product freshness, employing thermosensitive organic crystals that lose color when exposed to temperatures above a predetermined level. An active matrix incorporating the organic crystals is exposed to UV light to cause color development and then encapsulated in transparent UV-blocking plastic foil. The active matrix decay length can be varied by modifying the UV dosage. Reportedly, the indicator can be incorporated in a product's package as a sticker or embedded in the printing of the package. Related technology which could be employed in the present invention, as could be determined by one skilled in the art is disclosed in Haarer and Eichen International Patent Publication No. WO99/39197.

Also, Sjoholm, et al. disclose in U.S. Pat. No. 6,642,016 assigned to Bioett AB, describe an enzyme-based sensor which activates an antenna operating on swept RF which reportedly can sense and report environmental data. Agerhem, et al. U.S. Pat. No. 4,284,719, assigned to Kockums Chemical AB, discloses an enzymatic time-temperature indicating device employing a rupturable partition.

Zweig US Patent Publication No. 20040212509 discloses electronic time-temperature indicators with a visual output that can be employed to monitor the thermal history of a complex material.

Other proposed time-temperature indicating devices include: pH-indicator devices from Avery Dennison; microbiological devices from Cryolog; enzyme-based pH change devices from Vitsab; and a visible time-temperature indicating device employing a silver salt redox reaction. those skilled in the art may select any suitable ones of the foregoing time-temperature indicators, or other known time-temperature indicators, pursuant to the teachings herein, and adapt same by suitable matching, by selection, adjustment, programming or other means to desired host product characteristics, and suitable incorporation into host product devices and manufacturing and/or marketing methods, to provide useful indications of the incipient or actual maturity of maturing consumable products employing methods and/or devices of the invention such as are described herein.

If desired, a freeze indicator or other low-temperature spoilage indicator may be employed in combination with the described maturity indicator, as has been referenced hereinabove, to give a highly informative indication of the temperature exposure history and thence the condition and quality of a particular consumable product, especially frost-sensitive products such as soft fruits. One skilled in the art may select a suitable freeze indicator for use in a combination maturity and condition indicator, pursuant to the teachings of the invention herein from a wide variety of technologies.

For example, Ignacio, et al. U.S. Pat. No. 5,239,942, assigned to Pymah Corporation, discloses a freeze indicator comprising a frangible ampoule which is rupturable to release a dye that provides a color change. Shahinpoor U.S. Pat. No. 6,837,620, assigned to JP Labs, Inc., discloses a shape memory alloy temperature sensor having an alloy element that changes shape when exposed, even temporarily, to temperatures below a particular start temperature to provide a persistent indication of the temperature exposure. And Patel U.S. Pat. No. 6,472,214 discloses a freeze monitoring device comprising a color changing indicator, which may be a partially polymerized diacetylene which can undergo an irreversible color change, e.g., from blue to red, when the activator mixture is frozen in the region of about 0 to −30° C.

Other low-temperature threshold and freeze indicator devices and methods from which a suitable device or method for employment in the present invention may be selected are known to the art and some are disclosed in U.S. Pat. Nos. 5,111,768; 4,191,125; 5,215,378; 4,457,253; 4,148,748; 4,846,095; 2,971,852; and 4,028,944.

Thus, it may be seen from the foregoing description that the invention is widely applicable to broad classes of maturing foods, beverages and other consumable products, providing methods and products that can be employed by stores, distributors, manufacturers and others to assist consumers, enhance customer satisfaction, reduce shrinkage and help discriminate their brands from the brands of others.

While the invention has been described in terms of products intended for human consumption, it will be understood that the consumable products employed in practicing the invention may be intended for animal rather than human consumption, if desired.

Disclosures Incorporated. The entire disclosure of each and every United States patent and patent application, each foreign and international patent publication, of each other publication and of each unpublished patent application that is referenced in this specification or elsewhere in this patent application, is hereby incorporated herein, in its entirety, by the respective specific reference that has been made thereto.

It is anticipated that other embodiments and variations of the present invention will become readily apparent to the skilled artisan in the light of the foregoing description and examples, and such embodiments and variations are intended to likewise be included within the scope of the invention which is defined in the appended claims.

1. A process for marketing a maturing consumable product, the process comprising providing a visual maturity indicator with the maturing consumable product, the maturity indicator being cumulatively responsive to an environmental parameter affecting maturation and selecting the visual maturity indicator to have a response providing a visual indication correlated with a desired maturity of the consumable product.

2. A process according to claim 1 comprising:
a) determining the degree of maturity of the maturing consumable product prior to application of the environmental condition indicator;
b) selecting a degree of maturity of the consumable product to provide the desired maturity at a point of customer inspection;
c) determining a cumulative temperature exposure over time to provide the desired maturity of the consumable product;
d) selecting as the environmental condition-sensitive visual indicator a temperature-sensitive visual indicator having response characteristics corresponding with the determined cumulative temperature exposure to indicate when the desired degree of maturity of the consumable product has been reached; and
e) associating one of said time-temperature indicators with each consumable product unit to indicate product maturity at the point of customer inspection;
wherein the visual indicator has a distinctive appearance different from an initial appearance when the cumulative temperature exposure has occurred.

3. A process according to claim 2 wherein the indicator comprises a label attachable, optionally by means of adhesive, to a unit of the consumable product.

4. A process according to claim 3 wherein the label comprises a visual reference area facilitating visual determination of the appearance of the indicator.

5. A process according to claim 4 wherein the visual indicator provides multiple appearances responsive to different cumulative temperature exposures and wherein the indicator label is a multi-stage label having multiple reference areas useful for determining the visual appearance of the indicator at multiple stages of cumulative temperature exposure over time.

6. A process according to claim 4 wherein the maturing consumable product is selected from the group consisting of: fruits; apples; pears; kiwis; melons; grapes; grapefruit; bananas; peaches; nectarines; plums; pineapples; mangoes; guavas; dates; papayas; plantain; avocadoes; peppers; tomatoes; cheeses; soft cheese; brie cheese; camembert cheese; hard cheese; cheddar cheese; aging beef; aging steak; other aging meats and meat products; aging gourmet meats; gourmet hams; pheasant; gourmet game products; aging sausages; wines; Bordeaux wine, burgundy wine; claret; champagne; port; whisky; cognac; beverages that can benefit from maturation; and maturing consumable products lacking an inherent visual indication of maturity.

7. A process according to claim 4 wherein the indicator comprises a chemically active agent responsive to cumulative temperature exposure to provide a distinct change in visual appearance at the expiry of a predetermined cumulative temperature exposure.

8. A process according to claim 4 wherein the chemically active agent comprises at least one polyacetylenic active substance.

9. A process according to claim 6 comprising employing a maturity indicating label incorporating the visual indicator, the maturity indicating label being attached to the maturing consumable product unit, optionally by adhesive and wherein the consumer product unit comprises an individual consumer product item, piece or portion, the item piece or portion optionally being wrapped, a package, box, tray, crate or other carton containing multiple individual consumer product items, pieces or portions of a consumable product or a container containing a plurality of said boxes, trays, crates or cartons.

10. A process according to claim 4 wherein the maturing consumable product displays a green-to-red color change upon ripening and wherein the maturity indicator provides a ripeness-related indication visible to people with green-red impaired color vision.

11. A process according to claim 1 wherein the visual environmental condition indicator is responsive to an environmental condition selected from the group consisting of: cumulative temperature exposure over time; cumulative humidity exposure over time; cumulative concentration exposure over time to a maturity-affecting externally applied gaseous agent; cumulative concentration exposure over time of a carbon-dioxide sensitive consumable product to externally applied carbon dioxide; and cumulative concentration exposure over time of fruit to externally applied ethylene.

12. A process according to claim 1 comprising selecting the maturity indicator response parameters to relate to desired maturation conditions for the host product, the selected maturity indicator parameters being measured from a point of initiation of the maturity indicator, the point of initiation being correlated with the maturation process.

13. A process according to claim 2 wherein the host product comprises fruit, and the cumulative time-temperature exposure to maturation is provided by a temperature in the range of from about 5° C. to about 35° C. and a time of from about 1 day to about 30 days.

14. A process according to claim 2 wherein the host product comprises apples, and the cumulative time-temperature exposure to maturation is provided by a temperature in the range of from about −2° C. to about 2° C. and a time of from about 3 months to about 12 months.

15. A process according to claim 2 wherein the host product comprises bananas or plantains, and the cumulative time-temperature exposure to maturation is provided by a temperature in the range of from about 13° C. to about 14° C. and a time of from about 1 week to about 12 weeks.

16. A process according to claim 2 wherein the host product comprises cheese, and the cumulative time-temperature exposure to maturation is provided by a temperature in the range of from about 5° C. to about 20° C. and a time of from about 1 month to about 30 months.

17. A process according to claim 2 wherein the host product comprises brie or camembert cheese, and the cumulative time-temperature exposure to maturation is provided by a temperature in the range of from about 10° C. to about 15° C. and a time of from about 4 weeks to about 8 weeks.

18. A process according to claim 2 wherein the host product comprises cheddar cheese, and the cumulative time-temperature exposure to maturation is provided by a temperature in the range of from about 6° C. to about 8° C. and a time of from about 2 months to about 12 months.

19. A process according to claim 2 wherein the host product comprises Swiss cheese, and the cumulative time-temperature exposure to maturation is provided by a temperature in the range of from about 10° C. to about 20° C. and a time of from about 2 months to about 9 months.

20. A process according to claim 2 wherein the host product comprises sausage, and the cumulative time-temperature exposure to maturation is provided by a temperature in the range of from about 15° C. to about 30° C. and a time of from about 20 days to about 120 days.

21. A process according to claim 1 comprising monitoring the maturity of the host consumable product through a two-stage maturation process wherein the host product is matured in a first stage at a first temperature for a first period of time and in a second stage at a second temperature for a second period of time.

22. A process according to claim 21 wherein the host product comprises fruit, the first temperature is in the range of from about −2° C. to about 10° C., the first period is from about 2 days to about 1 year, the second temperature is about 10° C. to about 25° C. and the second period is from about 1 day to about one month.

23. A process according to claim 21 wherein the host product comprises pears, the first temperature is in the range of from about −0.5° C., the first period is from about 4 weeks to about 20 weeks, the second temperature is about 20° C. and the second period is from about 2 to about 7 days.

24. A process according to claim 1 comprising additionally employing: a threshold time-temperature indicator to monitor exposure of the host consumable product to potentially deleterious temperatures above a threshold temperature; a freeze indicator, or low-temperature exposure indicator to monitor exposure of the host consumable product to potentially deleterious temperatures below freezing or at low temperature; or both the threshold time-temperature indicator and a freeze indicator or low temperature exposure indicator.

25. A process according to claim 3 wherein the label comprises a combination label combining the maturity indicator and a radio frequency identification device in a single label to externally communicate information about the host product item.

26. A process according to claim 1 comprising employing a combination indicator wherein a cumulative time temperature indicator and a threshold indicator are integrated into a single device.

27. A process according to claim 1 wherein the maturity indicator employs an indicating technology selected from the group consisting of: color- and reflectivity-changing chemical polymerization-based active agents; poly acetylenic agents; diacetylenic agents; diffusion indicators; indicators requiring mechanical activation; indicators that employ the migration or diffusion of a viscoelastic material, optionally an adhesive, into a substrate to change the light transmissivity of the substrate; a color changing reaction wherein an oxidation-polymerizable dyestuff and an oxidizing agent are brought into contact with each other; use of a colored thermochromic material obscuring a patch of another color, colored thermochromic material being meltable and becoming transparent when exposed to a predetermined temperature; visible time-temperature indicating devices employing a silver salt redox reaction; indicating devices having a thermally sensitive image-forming area which comprises a combination of an organic silver salt oxidizing agent and a reducing agent; an indicator providing a visual reading of product freshness; employing ultraviolet light-activatable thermosensitive organic crystals in an active matrix that lose color when exposed to temperatures above a predetermined level, said active matrix being protected by transparent UV-blocking plastic foil after exposure to UV light to cause color development; enzyme-based sensors; enzyme-based sensors activating an antenna read by a swept RF signal; enzymatic time-temperature indicating devices employing a rupturable partitions; electronic time-temperature indicators having a visual output; pH-indicator devices; microbiological devices; and enzyme-based pH change devices.

28. A process according to claim 1 wherein the consumable product is aged beef and the maturity indicator is responsive to an exposure of from about 3 to about 30 days to a temperature in the range of from about 1° C. to about 10° C. measured from a time after slaughter when the beef first enters a cooler.

29. A process according to claim 1 wherein the consumable product is aged beef wherein the maturity indicator is temperature-responsive and is initiated and associated with the beef prior to admission of the beef to the aging chamber at a predetermined point in the process of preparation of the beef between slaughter and commencement of aging and wherein the response characteristics of the active component of the maturity indicator are selected to accommodate the anticipated time-temperature exposure prior to aging.

30. A maturing consumable product having a predictable temperature-related maturity profile and a maturity indicator visually associated with the consumable product the maturity indicator being temperature responsive to provide a visual indication predicted to correspond with a desired maturity of the consumable product.

31. A maturing consumable product according to claim 30 wherein the maturity indicator is cumulatively responsive to temperature exposure over time, provides a visual indication of a predetermined cumulative temperature exposure and is correlated with the temperature-related maturity profile of the consumable product to provide a visual indication of a desired maturity at the expiry of the predetermined cumulative temperature exposure.

32. A maturing consumable product according to claim 31 wherein the visual indicator comprises a label attachable, optionally by means of adhesive, to a unit of the consumable product.

33. A maturing consumable product according to claim 32 wherein the label comprises a reference area facilitating visual determination of the appearance of the indicator.

34. A maturing consumable product according to claim 30 wherein the visual indicator provides multiple appearances responsive to different cumulative temperature exposures and wherein the indicator label is a multi-stage label having multiple reference areas useful for determining the visual appearance of the indicator at multiple stages of cumulative temperature exposure over time.

35. A maturing consumable product according to claim 30 wherein the maturity indicator comprises: a threshold time-temperature indicator to monitor exposure of the host consumable product to potentially deleterious temperatures above a threshold temperature; a freeze indicator, or low-temperature exposure indicator to monitor exposure of the host consumable product to potentially deleterious temperatures below freezing or at low temperature; or both the threshold time-temperature indicator and a freeze indicator or low temperature exposure indicator.

36. A maturing consumable product according to claim 30 wherein the label comprises a combination label combining the maturity indicator and a radio frequency identification device in a single label to externally communicate information about the host product item.

37. A maturing consumable product according to claim 30 wherein the maturity indicator comprises a combination indicator wherein a cumulative time temperature indicator and a threshold indicator are integrated into a single device.

38. A maturing consumable product according to claim 30 wherein the maturity indicator employs an indicating technology selected from the group consisting of: color- and reflectivity-changing chemical polymerization-based active agents; poly acetylenic agents; diacetylenic agents; diffusion indicators; indicators requiring mechanical activation; indicators that employ the migration or diffusion of a viscoelastic material, optionally an adhesive, into a substrate to change the light transmissivity of the substrate; a color changing reaction wherein an oxidation-polymerizable dyestuff and an oxidizing agent are brought into contact with each other; use of a colored thermochromic material obscuring a patch of another color, colored thermochromic material being meltable and becoming transparent when exposed to a predetermined temperature; visible time-temperature indicating devices employing a silver salt redox reaction; indicating devices having a thermally sensitive image-forming area which comprises a combination of an organic silver salt oxidizing agent and a reducing agent; an indicator providing a visual reading of product freshness; employing ultraviolet light-activatable thermosensitive organic crystals in an active matrix that lose color when exposed to temperatures above a predetermined level, said active matrix being protected by transparent UV-blocking plastic foil after exposure to UV light to cause color development; enzyme-based sensors; enzyme-based sensors activating an antenna read by a swept RF signal; enzymatic time-temperature indicating devices employing a rupturable partitions; electronic time-temperature indicators having a visual output; pH-indicator devices; microbiological devices; and enzyme-based pH change devices.

39. A maturing consumable product according to claim 30 wherein the maturing consumable product is selected from the group consisting of: fruits; pears; kiwis; melons; grapes; grapefruit; bananas; peaches; nectarines; plums; pineapples; mangoes; papayas; plantain; avocadoes; tomatoes; cheeses; soft cheese; brie cheese; camembert cheese; hard cheese; cheddar cheese; aging beef; aging steak; other aging meats and meat products; aging gourmet meats; gourmet hams; pheasant; gourmet game products; aging sausages; wines; Bordeaux wine, burgundy wine; claret; champagne; port; whisky; cognac; beverages that can benefit from maturation; and maturing consumable products lacking an inherent visual indication of maturity.

40. A maturing consumable product according to claim 30 wherein the indicator comprises a chemically active agent responsive to cumulative temperature exposure to provide a distinct change in visual appearance at the expiry of a predetermined cumulative temperature exposure.

41. A maturing consumable product according to claim 40 wherein the chemically active agent comprises at least one polyacetylenic active substance.

42. A maturing consumable product according to claim 30 comprising employing a maturity indicating label incorporating the visual indicator, the maturity indicating label being attached to the maturing consumable product unit, optionally by adhesive and wherein the consumer product unit comprises an individual consumer product item, piece or portion, the item piece or portion optionally being wrapped, a package, box, tray, crate or other carton containing multiple individual consumer product items, pieces or portions of a consumable product or a container containing a plurality of said boxes, trays, crates or cartons.

43. A maturing consumable product according to claim 31 wherein the maturing consumable product displays a green-to-red color change upon ripening and wherein the maturity indicator provides a ripeness-related indication visible to people with green-red impaired color vision.

44. A maturing consumable product according to claim 30 wherein the visual environmental condition indicator is responsive to an environmental condition selected from the group consisting of: cumulative temperature exposure over time; cumulative humidity exposure over time; cumulative concentration exposure over time to a maturity-affecting gaseous agent; cumulative concentration exposure over time of a carbon-dioxide sensitive consumable product to carbon dioxide; and cumulative concentration exposure over time of ethylene-sensitive fruits to ethylene.

45. A maturing consumable product according to claim 30 wherein the consumable product is wine or port and the maturity indicator is responsive to an exposure of from about one to about fifty years and to a temperature in the range of from about 5° C. to about 25° C.
